(19) United States
(12) Patent Application Publication
(10) Pub. No.: US 2024/0176106 A1
(43) Pub. Date: May 30, 2024

(54) Optical Imaging Lens Assembly

(71) Applicant: ZHEJIANG SUNNY OPTICS CO., LTD., Ningbo (CN)

(72) Inventors: Huilong LI, Ningbo (CN); Quanfeng YANG, Ningbo (CN); Chao WANG, Ningbo (CN); Zongliang ZHENG, Ningbo (CN); Fujian DAI, Ningbo (CN); Liefeng ZHAO, Ningbo (CN)

(21) Appl. No.: 18/128,252

(22) Filed: Mar. 30, 2023

(30) Foreign Application Priority Data
Nov. 28, 2022 (CN) 202211502147.1

(51) Int. Cl. G02B 13/00; G02B 7/02; G02B 9/60

(52) U.S. Cl. CPC G02B 13/0045; G02B 7/021; G02B 9/60

(57) ABSTRACT

The disclosure provides an optical imaging lens assembly. The optical imaging lens assembly includes a lens barrel, wherein the lens barrel is internally provided with a first lens; a second lens; a third lens; a fourth lens, wherein the fourth lens has a positive refractive power; a fifth lens, wherein the fifth lens has the largest outer diameter in all of lenses of the optical imaging lens assembly; and a plurality of spacers, wherein the plurality of spacers at least include a fourth spacer, the fourth spacer is located on an image side of the fourth lens and abuts against an image-side surface of the fourth lens, and the fourth spacer is thicker than remaining spacers; wherein f and FOV and CP4 satisfy 0<f*tan(Semi-FOV)/CP4<10; R8 and R9 and CP4 satisfy 0<(R8+R9)/CP4<15. The disclosure solves the problem of a low yield of the optical imaging lens assembly.

### CROSS-REFERENCE TO RELATED APPLICATION

This disclosure claims priority to Patent Application No. 202211502147.1, filed to China National Intellectual Property Administration on Nov. 28, 2022 and entitled “Optical Imaging Lens Assembly”, the disclosure of which is hereby incorporated by reference in its entirety.

### TECHNICAL FIELD

The disclosure relates to the technical field of imaging apparatuses, and particularly relates to an optical imaging lens assembly.

### BACKGROUND

With the continuous upgrade and iteration of smart phones and other portable electronic apparatuses, requirements for an optical imaging lens assembly mounted on an apparatus keep increasing. In order to enhance user experience, requirements for the sizes of the optical imaging lens assembly and a camera are more stringent, and lenses with an ultra-small camera and a large image surface are popular in the market. In the case of the small-camera optical imaging lens assembly, space at the front end is narrow, rendering narrower space for glue dispensing operation. Accordingly, unqualified dispensing is likely to occur, causing poor tightness of connection between the lens and a lens barrel after the lens and a spacer are fitted into the lens barrel, and further causing unstable assembly. Besides, a too thin rear spacer is likely to deform, so a support force of a rear system to a front lens is insufficient, resulting in that the lens is likely to tilt and fall during a reliability test, greatly reducing a product yield. Moreover, an irrational shape of the lens will lead to weld lines or shrinkage of a surface type of the lens, and will also affect the stability of fit between the lens and the spacer, greatly reducing the yield.

That is, the optical imaging lens assembly in the related art has a problem of a low yield.

### SUMMARY

A main objective of the disclosure is to provide an optical imaging lens assembly, to solve the problem of a low yield of the optical imaging lens assembly in the related art.

In order to achieve the above objective, according to an embodiment of the disclosure, provided is an optical imaging lens assembly. The optical imaging lens assembly includes a lens barrel, wherein the lens barrel is internally provided with a first lens; a second lens; a third lens; a fourth lens, wherein the fourth lens has a positive refractive power; a fifth lens, wherein the fifth lens has the largest outer diameter in all of lenses of the optical imaging lens assembly; and a plurality of spacers, wherein the plurality of spacers at least include a fourth spacer, the fourth spacer is located on an image side of the fourth lens and abuts against an image-side surface of the fourth lens, and the fourth spacer is thicker than remaining spacers of the plurality of spacers; wherein f is an effective focal length of the optical imaging lens assembly, FOV is a half of a maximum field of view of the optical imaging lens assembly, and CP4 is a thickness of the fourth spacer, f and FOV and CP4 satisfy 0<f*tan(Semi-FOV)/CP4<10; and R8 is a curvature radius of the image-side surface of the fourth lens, R9 is a curvature radius of an object-side surface of the fifth lens, R8 and R9 and CP4 satisfy 0<(R8+R9)/CP4<15.

In an exemplary embodiment, a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, a spacer of the plurality of spacers located on an image side of the third lens and abutting against an image-side surface of the third lens is a third spacer, and EP12 is a distance between the first spacer and the second spacer, EP23 is a distance between the second spacer and the third spacer, CT2 is a center thickness of the second lens, EP12 and EP23 and CT2 and CT3 is a center thickness of the third lens satisfy 2<EP12/CT2+EP23/CT3<5.

In an exemplary embodiment, a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, a spacer of the plurality of spacers located on an image side of the third lens and abutting against an image-side surface of the third lens is a third spacer, and EP12 is a distance between the first spacer and the second spacer, EP23 is a distance between the second spacer and the third spacer, f1 is an effective focal length of the first lens, and f2 is an effective focal length of the second lens, EP12 and EP23 and f1 and f2 satisfy −25<f1/EP12+f2/EP23<0.

In an exemplary embodiment, a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, the second lens has the smallest center thickness in all of the lenses of the optical imaging lens assembly, and CP1 is a thickness of the first spacer, EP12 is a distance between the first spacer and the second spacer, CP2 is a thickness of the second spacer, and CT2 is a center thickness of the second lens, EP12 and CP1 and CT2 and CP2 satisfy 1<(CP1+EP12+CP2)/CT2<4.

In an exemplary embodiment, a spacer of the plurality of spacers located on an image side of the third lens and abutting against an image-side surface of the third lens is a third spacer, and T34 is an on-axis distance from the image-side surface of the third lens to an object-side surface of the fourth lens, CT4 is a center thickness of the fourth lens, T45 is an on-axis distance from the image-side surface of the fourth lens to an object-side surface of the fifth lens, CP3 is a thickness of the third spacer, and CP4 is a thickness of the fourth spacer, T34 and T45 and CT4 and CP3 and CP4 satisfy 1<(T34+CT4+T45)/(CP3+CP4)<5.

In an exemplary embodiment, a spacer of the plurality of spacers located on an image side of the second lens and abutting against an image-side surface of the second lens is a second spacer, a spacer of the plurality of spacers located on an image side of the third lens and abutting against an image-side surface of the third lens is a third spacer, and f3 is an effective focal length of the third lens, EP23 is a distance between the second spacer and the third spacer, f4 is an effective focal length of the fourth lens, and EP34 is a distance between the third spacer and the fourth spacer, EP23 and EP34 and f3 and f4 satisfy −70<f3/EP23+f4/EP34<80.

In an exemplary embodiment, the optical imaging lens assembly further includes a fourth auxiliary spacer located on an image side of the fourth spacer and abutting against an image-side surface of the fourth spacer, wherein CP4 is a thickness of the fourth spacer, CP4b is a thickness of the fourth auxiliary spacer, and T45 is an on-axis distance from the image-side surface of the fourth lens to an object-side surface of the fifth lens, T45 and CP4b and CP4 satisfy 0<(CP4+CP4b)/T45<11.

In an exemplary embodiment, f4 is an effective focal length of the fourth lens, f5 is an effective focal length of the fifth lens, and CP4 is a center thickness of the fourth lens, f4 and f5 and CP4 satisfy 5<(f4-f5)/CP4<25.

In an exemplary embodiment, a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, the second lens has the largest refractive index in all of the lenses of the optical imaging lens assembly, and R3 is a curvature radius of an object-side surface of the second lens, R4 is a curvature radius of an image-side surface of the second lens, CP1 is a thickness of the first spacer, and CP2 is a thickness of the second spacer, R3 and R4 and CP1 and CP2 satisfy −10<R3/R4+CP1/CP2<5.

In an exemplary embodiment, TD is an on-axis distance from the object-side surface of the first lens to the image-side surface of the fifth lens, and ΣCP is a sum of thicknesses of all of the spacers, ΣCP and TD satisfy 3<TD/ΣCP<8.

In an exemplary embodiment, a spacer of the plurality of spacers located on an image side of the first lens and abutting against the image-side surface of the first lens is a first spacer, a spacer of the plurality of spacers located on an image side of the second lens and abutting against an image-side surface of the second lens is a second spacer, a spacer of the plurality of spacers located on an image side of the third lens and abutting against an image-side surface of the third lens is a third spacer, and f is an effective focal length of the optical imaging lens assembly, CP1 is a thickness of the first spacer, CP2 is a thickness of the second spacer, CP3 is a thickness of the third spacer, and CP4 is a thickness of the fourth spacer, f and CP1 and CP2 and CP3 and CP4 satisfy 0<f/(CP1+CP2+CP3+CP4)<10.

In an exemplary embodiment, when an image-side surface of an ith lens of the lense and an object-side surface of an (i+1)th lens of the lenses are concave surfaces, T(i, i+1) is an on-axis distance between the image-side surface of the ith lens and the object-side surface of the (i+1)th lens, and CPi is a thickness of an ith spacer of the plurality of spacers satisfy 0<T(i, i+1)/CPi<25, wherein the ith spacer is a spacer of the plurality of spacers located on an image side of the ith lens and abutting against the image-side surface of the ith lens, and i is able to be 1, 2, 3 and 4.

In an exemplary embodiment, at least two of the first lens to the fifth lens have positive refractive powers.

In an exemplary embodiment, the first lens has a positive refractive power, and the fifth lens has a negative refractive power.

In an exemplary embodiment, the first lens is a meniscus lens having a convex object-side surface.

In an exemplary embodiment, a refractive index of at least one lens of the optical imaging lens assembly is greater than that of the first lens.

In an exemplary embodiment, f1 is an effective focal length of the first lens, f2 is an effective focal length of the second lens, and f3 is an effective focal length of the third lens, f1 and f2 and f3 satisfy |f1|<|f2|<|f3|.

According to another embodiment of the disclosure, provided is an optical imaging lens assembly. The optical imaging lens assembly includes a lens barrel, wherein the lens barrel is internally provided with a first lens; a second lens; a third lens; a fourth lens, wherein the fourth lens has a positive refractive power; a fifth lens, wherein the fifth lens has the largest outer diameter in all of the lenses of the optical imaging lens assembly; and a plurality of spacers, wherein the plurality of spacers at least include a third spacer and a fourth spacer, the third spacer is located on an image side of the third lens and abuts against an image-side surface of the third lens, the fourth spacer is located on an image side of the fourth lens and abuts against an image-side surface of the fourth lens, and the fourth spacer is thicker than the remaining spacers of the plurality of spacers; wherein T34 is an on-axis distance from the image-side surface of the third lens to an object-side surface of the fourth lens, CT4 is a center thickness of the fourth lens, T45 is an on-axis distance from the image-side surface of the fourth lens to an object-side surface of the fifth lens, CP3 is a thickness of the third spacer, and CP4 is a thickness of the fourth spacer, T34 and T45 and CT4 and CP3 and CP4 satisfy 1<(T34+CT4+T45)/(CP3+CP4)<5.

In an exemplary embodiment, a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, and EP12 is a distance between the first spacer and the second spacer, EP23 is a distance between the second spacer and the third spacer, CT2 is a center thickness of the second lens, and CT3 is a center thickness of the third lens, EP12 and CT2 and EP23 and CT3 satisfy 2<EP12/CT2+EP23/CT3<5.

In an exemplary embodiment, a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, and EP12 is a distance between the first spacer and the second spacer, EP23 is a distance between the second spacer and the third spacer, f1 is an effective focal length of the first lens, and f2 is an effective focal length of the second lens, f1 and EP12 and f2 and EP23 satisfy −25<f1/EP12+f2/EP23<0.

In an exemplary embodiment, a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, the second lens has the smallest center thickness in all of the lenses of the optical imaging lens assembly, and CP1 is a thickness of the first spacer, EP12 is a distance between the first spacer and the second spacer, CP2 is a thickness of the second spacer, and CT2 is a center thickness of the second lens, CP1 and EP12 and CP2satisfy 1<(CP1+EP12+CP2)/CT2<4.

In an exemplary embodiment, a spacer of the plurality of spacers located on an image side of the second lens and abutting against an image-side surface of the second lens is a second spacer, and f3 is an effective focal length of the third lens, EP23 is a distance between the second spacer and the third spacer, f4 is an effective focal length of the fourth lens, and EP34 is a distance between the third spacer and the fourth spacer, f3 and EP23 and f4 and EP34 satisfy −70<f3/EP23+f4/EP34<80.

In an exemplary embodiment, the optical imaging lens assembly further includes a fourth auxiliary spacer located on an image side of the fourth spacer and abutting against an image-side surface of the fourth spacer, wherein CP4 is a thickness of the fourth spacer, CP4b is a thickness of the fourth auxiliary spacer, and T45 is an on-axis distance from the image-side surface of the fourth lens to an object-side surface of the fifth lens, CP4 and CP4b and T45 satisfy 0<(CP4+CP4b)/T45<11.

In an exemplary embodiment, f4 is an effective focal length of the fourth lens, f5 is an effective focal length of the fifth lens, and CP4 is a center thickness of the fourth lens, f4 and f5 and CP4 satisfy 5<(f4-f5)/CP4<25.

In an exemplary embodiment, a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, the second lens has the largest refractive index in all of the lenses of the optical imaging lens assembly, and R3 is a curvature radius of an object-side surface of the second lens, R4 is a curvature radius of an image-side surface of the second lens, CP1 is a thickness of the first spacer, and CP2 is a thickness of the second spacer, R3 and R4 and CP1 and CP2 satisfy −10<R3/R4+CP1/CP2<5.

In an exemplary embodiment, TD is an on-axis distance from the object-side surface of the first lens to the image-side surface of the fifth lens, and ΣCP is a sum of thicknesses of all of the spacers, TD and ΣCP satisfy 3<TD/ΣCP<8.

In an exemplary embodiment, a spacer of the plurality of spacers located on an image side of the first lens and abutting against the image-side surface of the first lens is a first spacer, a spacer of the plurality of spacers located on an image side of the second lens and abutting against an image-side surface of the second lens is a second spacer, and f is an effective focal length of the optical imaging lens assembly, CP1 is a thickness of the first spacer, CP2 is a thickness of the second spacer, CP3 is a thickness of the third spacer, and CP4 is a thickness of the fourth spacer, f and CP1 and CP2 and CP3 and CP4 satisfy 0<f/(CP1+CP2+CP3+CP4)<10.

In an exemplary embodiment, when an image-side surface of an ith lens and an object-side surface of an (i+1)th lens are concave surfaces, T(i, i+1) is an on-axis distance between the image-side surface of the ith lens and the object-side surface of the (i+1)th lens, and CPi is a thickness of an ith spacer, T(i, i+1) and CPi satisfy 0<T(i, i+1)/CPi<25, wherein the ith spacer is a spacer of the plurality of spacers located on an image side of the ith lens and abutting against the image-side surface of the ith lens, and i is able to be 1, 2, 3 and 4.

In an exemplary embodiment, at least two of the first lens to the fifth lens have positive refractive powers.

In an exemplary embodiment, the first lens has a positive refractive power, and the fifth lens has a negative refractive power.

In an exemplary embodiment, the first lens is a meniscus lens having a convex object-side surface.

In an exemplary embodiment, a refractive index of at least one lens of the optical imaging lens assembly is greater than that of the first lens.

In an exemplary embodiment, f1 is an effective focal length of the first lens, f2 is an effective focal length of the second lens, and f3 is an effective focal length of the third lens, f1 and f2 and f3 satisfy |f1|<|f2|<|f3|.

By using the technical solution of the disclosure, the optical imaging lens assembly includes a lens barrel, wherein the lens barrel is internally provided with a first lens; a second lens; a third lens; a fourth lens, wherein the fourth lens has a positive refractive power; a fifth lens, wherein the fifth lens has the largest outer diameter in all of the lenses of the optical imaging lens assembly; and a plurality of spacers, wherein the plurality of spacers at least include a fourth spacer, the fourth spacer is located on an image side of the fourth lens and abuts against an image-side surface of the fourth lens, and the fourth spacer is thicker than the remaining spacers; wherein f is an effective focal length of the optical imaging lens assembly, FOV is a half of a maximum field of view of the optical imaging lens assembly, and CP4 is a thickness of the fourth spacer, f and FOV and CP4 satisfy 0<f*tan(Semi-FOV)/CP4<10; and R8 is a curvature radius of the image-side surface of the fourth lens, R9 is a curvature radius of an object-side surface of the fifth lens, R8 and R9 and CP4 satisfy 0<(R8+R9)/CP4<15.

The fifth lens has the largest outer diameter in all of the lenses of the optical imaging lens assembly, such that a larger operation space is provided for assembly of a front lens of the small-camera optical imaging lens assembly, to avoid collision of the spacers and the lenses with the lens barrel, and a larger operation space is also provided for glue dispensing of the front lens and the spacer, to facilitate flow of glue into a position to be dispensed. The tightness of connection between the lenses and the lens barrel is guaranteed, then the stability during assembly is guaranteed, and the yield of the optical imaging lens assembly is improved. In the disclosure, f, FOV and CP4 are interrelated, the thickness of the fourth spacer is controlled within a reasonable range, to avoid deformation or shaking caused by the fourth spacer being too thin, so as to form a strong support for the fourth lens, and to guarantee the stability of assembly between the fourth spacer and the lenses or spacers on two sides, thereby effectively increasing the yield of the optical imaging lens assembly. Furthermore, through matching of the radii of curvature of the fourth lens and the fifth lens, shapes of surfaces of the fourth lens and the fifth lens facing the fourth spacer are able to be effectively ensured, such that the fourth lens and the fifth lens may stably clamp the fourth spacer, to further form a strong support for the front lens, thereby guaranteeing the stability of the assembly between the fourth spacer and the lenses or spacers on two sides. Moreover, the shapes of the fourth lens and the fifth lens are able to be effectively controlled, to avoid weld lines or shrinkage of surface types, and further to guarantee the stability of assembly of the lenses and spacers from the fourth lens to the fifth lens, thereby improving the yield of the optical imaging lens assembly.

### BRIEF DESCRIPTION OF THE DRAWINGS

The accompanying drawings of the specification forming a part of the disclosure serve to provide a further understanding of the disclosure, and the illustrative embodiments of the disclosure and the description of the illustrative embodiments serve to explain the disclosure and are not to be construed as unduly limiting the disclosure. In the drawings:

FIG. 1 is a schematic structural diagram of an optical imaging lens assembly according to an optional embodiment of the disclosure;

FIGS. 2-4 are schematic structural diagrams of an optical imaging lens assembly in a first state, a second state and a third state according to Example 1 of the disclosure;

FIGS. 5-8 illustrate a longitudinal chromatic aberration curve, a lateral color curve, an astigmatism curve and a distortion curve respectively according to Example 1 of the disclosure;

FIGS. 9-11 are schematic structural diagrams of an optical imaging lens assembly in a first state, a second state and a third state according to Example 2 of the disclosure;

FIGS. 12-15 illustrate a longitudinal chromatic aberration curve, a lateral color curve, an astigmatism curve and a distortion curve respectively according to Example 2 of the disclosure;

FIGS. 16-18 are schematic structural diagrams of an optical imaging lens assembly in a first state, a second state and a third state according to Example 3 of the disclosure; and

FIGS. 19-22 illustrate a longitudinal chromatic aberration curve, a lateral color curve, an astigmatism curve and a distortion curve respectively according to Example 3 of the disclosure.

The above-mentioned figures include the following reference numerals:
P0, lens barrel; E1, first lens; S1, object-side surface of first lens; S2, image-side surface of first lens; P1, first spacer; E2, second lens; S3, object-side surface of second lens; S4, image-side surface of second lens; P2, second spacer; E3, third lens; S5, object-side surface of third lens; S6, image-side surface of third lens; P3, third spacer; P3b, third auxiliary spacer; E4, fourth lens; S7, object-side surface of fourth lens; S8, image-side surface of fourth lens; P4, fourth spacer; P4b, fourth auxiliary spacer; E5, fifth lens; S9, object-side surface of fifth lens; and S10, image-side surface of fifth lens.

### DETAILED DESCRIPTION OF THE EMBODIMENTS

It should be noted that the embodiments in the present application and features in the embodiments can be combined without conflicts. The disclosure will be described in detail below with reference to the accompanying drawings in conjunction with examples.

It is to be noted that unless otherwise defined, all technical and scientific terms used in the disclosure have the same meanings usually understood by the general technical personnel in the technical field of the disclosure.

In the disclosure, directional terms such as “upper”, “lower”, “top”, and “bottom” are used generally with respect to directions shown in the drawings, or with respect to vertical, perpendicular, or gravitational directions of components, without being described to the contrary. Similarly, for ease of understanding and description, “inner” and “outer” refer to inner and outer relative to contours of the components, but the above directional terms are not intended to limit the disclosure.

It should be noted that throughout this specification, the recitations of first, second, third, etc. are used merely to distinguish one feature from another and do not represent any limitation on the feature. Thus, the first lens discussed below may also be referred to as the second lens or the third lens without departing from the teachings of the disclosure.

In the accompanying drawings, the thickness, size, and shape of the lens have been slightly exaggerated for ease of illustration. Specifically, a spherical shape or an aspheric shape shown in the drawings is shown by some examples. That is to say that the spheric or aspheric shape is not limited to the spheric or aspheric shape shown in the accompanying drawings. The drawings are by way of example only and not strictly to scale.

A paraxial region refers to a region near an optical axis herein. Under the condition that a surface of a lens is a convex surface and a position of the convex surface is not defined, the surface of the lens is a convex surface at least in the paraxial region; and under the condition that the surface of the lens is a concave surface and the position of the concave surface is not defined, the surface of the lens is a concave surface at least in the paraxial region. A surface type of concave or convex at a paraxial region is able to be determined by means of positive or negative of a value of R (R refers to a curvature radius of the paraxial region, and generally refers to a value of R on a lens data in optical software) according to a determination method of a person skilled in the art. As for an object-side surface, when the value of R is positive, the object-side surface is determined to be a convex surface, and when the value of R is negative, the object-side surface is determined to be a concave surface. As for an image-side surface, when the value of R is positive, the image-side surface is determined to be a concave surface, and when the value of R is negative, the image-side surface is determined to be a convex surface.

To solve the low yield of the optical imaging lens assembly in the related art, the disclosure provides an optical imaging lens assembly.

### Embodiment 1

As shown in FIGS. 1-22, an optical imaging lens assembly includes a lens barrel P0, wherein the lens barrel P0 is internally provided with a first lens; a second lens; a third lens; a fourth lens, wherein the fourth lens has a positive refractive power; a fifth lens, wherein the fifth lens has the largest outer diameter in all of lenses of the optical imaging lens assembly; and a plurality of spacers, wherein the plurality of spacers at least include a fourth spacer, the fourth spacer is located on an image side of the fourth lens and abuts against an image-side surface of the fourth lens, and the fourth spacer is thicker than remaining spacers of the plurality of spacers; wherein f is an effective focal length of the optical imaging lens assembly, FOV is a half of a maximum field of view of the optical imaging lens assembly, and CP4 is a thickness of the fourth spacer, f and FOV and CP4 satisfy 0<f*tan(Semi-FOV)/CP4<10; and R8 is a curvature radius of the image-side surface of the fourth lens, R9 is a curvature radius of an object-side surface of the fifth lens, R8 and R9 and CP4 satisfy 0<(R8+R9)/CP4<15.

The fifth lens has the largest outer diameter in all of the lenses of the optical imaging lens assembly, such that a larger operation space is provided for assembly of a front lens of the small-camera optical imaging lens assembly, to avoid collision of the spacers and the lenses with the lens barrel P0, and a larger operation space is also provided for glue dispensing of the front lens and the spacer, to facilitate flow of glue into a position to be dispensed. The tightness of connection between the lenses and the lens barrel P0 is guaranteed, then the stability during assembly is guaranteed, and the yield of the optical imaging lens assembly is improved. In the disclosure, f, FOV and CP4 are interrelated, the thickness of the fourth spacer is controlled within a reasonable range, to avoid deformation or shaking caused by the fourth spacer being too thin, so as to form a strong support for the front lens, and to guarantee the stability of assembly between the lenses, thereby effectively increasing the yield of the optical imaging lens assembly. Furthermore, through matching of the radii of curvature of the fourth lens and the fifth lens, shapes of surfaces of the fourth lens and the fifth lens facing the fourth spacer are able to be effectively ensured, such that the fourth lens and the fifth lens may stably clamp the fourth spacer, to further form a strong support for the front lens, thereby guaranteeing the stability of assembly. Moreover, the shapes of the fourth lens and the fifth lens are able to be effectively controlled, to avoid weld lines or shrinkage of surface types, and further to guarantee the stability of assembly, thereby improving the yield of the optical imaging lens assembly.

By controlling f*tan(Semi-FOV)/CP4 within a reasonable range, the optical imaging lens assembly of the disclosure may increase a field of view by controlling the thickness of the fourth spacer under the condition that the effective focal length of the optical imaging lens assembly is unchanged, so as to guarantee an overall dimension and an imaging effect of the optical imaging lens assembly. Preferably, 4.76sf*tan(Semi-FOV)/CP4≤9.41.

By controlling (R8+R9)/CP4 within a reasonable range, the optical imaging lens assembly of the disclosure also guarantees processing forming of the fourth lens and the fifth lens, so as to guarantee the imaging quality of the optical imaging lens assembly. Preferably, 0.94≤(R8+R9)/CP4≤12.54.

In this embodiment, a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, a spacer of the plurality of spacers located on an image side of the third lens and abutting against an image-side surface of the third lens is a third spacer, and EP12 is a distance between the first spacer and the second spacer, EP23 is a distance between the second spacer and the third spacer, CT2 is a center thickness of the second lens, and CT3 is a center thickness of the third lens, EP12 and EP23 and CT2 and CT3 satisfy 2<EP12/CT2+EP23/CT3<5. By controlling EP12/CT2+EP23/CT3 within a reasonable range, a ratio of an edge thickness to a center thickness of the second lens and the third lens is more reasonable, the risk of appearance defects of the second lens and the third lens is reduced, the forming yield of the second lens and the third lens is greatly improved, and a better coincidence between a surface profile curve of an optically active portion of the lens and a design value is able to be achieved, such that resolution of the optical imaging lens assembly is closer to the design value, and the imaging effect is improved. Preferably, 2.68≤EP12/CT2+EP23/CT3≤3.92.

In this embodiment, a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, a spacer of the plurality of spacers located on an image side of the third lens and abutting against an image-side surface of the third lens is a third spacer, and EP12 is a distance between the first spacer and the second spacer, EP23 is a distance between the second spacer and the third spacer, f1 is an effective focal length of the first lens, and f2 is an effective focal length of the second lens, EP12 and EP23 and f1 and f2 satisfy −25<f1/EP12+f2/EP23<0. By controlling f1/EP12+f2/EP23 within a reasonable range, it is able to be guaranteed that after light passes through the first lens and the second lens, an entire image height increases. Furthermore, by controlling distances between the first spacer, the second spacer and the third spacer, image height matching with a chip is able to be satisfied while a length of the lens barrel P0 is reduced, such that a structure of the optical imaging lens assembly is more compact, which is conducive to reducing the size of the optical imaging lens assembly and saving space for a carrier apparatus. Preferably, −23.96≤f1/EP12+f2/EP23≤−4.22.

In this embodiment, a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, the second lens has the smallest center thickness in all of the lenses of the optical imaging lens assembly, and CP1 is a thickness of the first spacer, EP12 is a distance between the first spacer and the second spacer, CP2 is a thickness of the second spacer, and CT2 is a center thickness of the second lens, EP12 and CP1 and CT2 and CP2 satisfy 1<(CP1+EP12+CP2)/CT2<4. By controlling (CP1+EP12+CP2)/CT2 within a reasonable range, a ratio of the center thickness to the edge thickness of the second lens is able to be guaranteed to fall within a reasonable range, the center thickness and the edge thickness of the second lens is able to be guaranteed to be uniform, processability of the second lens is able to be guaranteed, the manufacturing yield of the second lens is able to be improved, and then the assembly yield of the optical imaging lens assembly is able to be improved. The stability of formation and assembly of the first spacer, the second lens and the second spacer may also be guaranteed, to avoid deformation of the spacer, and to guarantee the yield of the optical imaging lens assembly. Furthermore, a resolution performance of the optical imaging lens assembly is able to be significantly improved in extreme environments such as high temperature and humidity. Preferably, 1.98≤(CP1+EP12+CP2)/CT2≤3.20.

In this embodiment, a spacer of the plurality of spacers located on an image side of the third lens and abutting against an image-side surface of the third lens is a third spacer, and T34 is an on-axis distance from the image-side surface of the third lens to an object-side surface of the fourth lens, CT4 is a center thickness of the fourth lens, T45 is an on-axis distance from the image-side surface of the fourth lens to an object-side surface of the fifth lens, CP3 is a thickness of the third spacer, and CP4 is a thickness of the fourth spacer, T34 and T45 and CT4 and CP3 and CP4 satisfy 1<(T34+CT4+T45)/(CP3+CP4)<5. By controlling (T34+CT4+T45)/(CP3+CP4) within a reasonable range, a difference between the edge thickness and the center thickness of the third lens, and a difference between an edge thickness and the center thickness of the fourth lens is able to be guaranteed to fall within a controllable range, such that processing forming of the third lens and the fourth lens are able to be guaranteed, and the yield of the optical imaging lens assembly is able to be improved. Furthermore, limiting the thicknesses of the third spacer and the fourth spacer helps to improve smoothness of edge transition of the third lens and the fourth lens, such that smooth transition between abutting portions and optically active portions of the third lens and the fourth lens is able to be achieved, avoiding generation of stress concentration regions, the yield of the optical imaging lens assembly is improved, and the ability of the optical imaging lens assembly to resist harsh environments is also improved. Preferably, 1.80≤(T34+CT4+T45)/(CP3+CP4)≤4.45.

In this embodiment, a spacer of the plurality of spacers located on an image side of the second lens and abutting against an image-side surface of the second lens is a second spacer, a spacer of the plurality of spacers located on an image side of the third lens and abutting against an image-side surface of the third lens is a third spacer, and f3 is an effective focal length of the third lens, EP23 is a distance between the second spacer and the third spacer, f4 is an effective focal length of the fourth lens, and EP34 is a distance between the third spacer and the fourth spacer, EP23 and EP34 and f3 and f4 satisfy −70<f3/EP23+f4/EP34<80. By controlling f3/EP23+f4/EP34 within a reasonable range, ratios of the focal lengths to the edge thicknesses of the third lens and the fourth lens fall within a controllable range, and the bending degree and the edge thickness of the lenses fall within a controllable range, such that the risk of producing weld lines during injection molding of the lens are able to be significantly reduced, the formability of the third lens and the fourth lens is improved, and the yield of the optical imaging lens assembly is improved. Preferably, −66.20≤f3/EP23+f4/EP34≤72.53.

In this embodiment, the optical imaging lens assembly further includes a fourth auxiliary spacer located on an image side of the fourth spacer and abutting against an image-side surface of the fourth spacer, wherein CP4 is a thickness of the fourth spacer, CP4b is a thickness of the fourth auxiliary spacer, and T45 is an on-axis distance from the image-side surface of the fourth lens to an object-side surface of the fifth lens, T45 and CP4b and CP4 satisfy 0<(CP4+CP4b)/T45<11. Arrangement of the fourth auxiliary spacer helps to avoid stray light generated from an inner surface of the fourth spacer, so as to enhance the imaging effect. Furthermore, by controlling (CP4+CP4b)/T45 within a reasonable range, a large gap of the structural portions of the fourth lens and the fifth lens is able to be rationally distributed on two spacers, to guarantee the stability of assembly of the large gap position, and improve the yield of the optical imaging lens assembly. Preferably, 0.48≤(CP4+CP4b)/T45≤10.81.

In this embodiment, f4 is an effective focal length of the fourth lens, f5 is an effective focal length of the fifth lens, and CP4 is a center thickness of the fourth lens, f4 and f5 and CP4 satisfy 5<(f4-f5)/CP4<25. By controlling (f4-f5)/CP4 within a reasonable range, an excessive gap between an edge of the fourth lens and an edge of the fifth lens is able to be effectively reduced, so as to avoid unstable assembly and abutting of the fourth lens and the fifth lens. The situation of direct abutting of two lenses may further be avoided when the gap is too small. Since there is a large difference in apertures of the fourth lens and the fifth lens, direct abutting of the two lenses may cause a risk of deformation and fracturing of the fourth lens, such that limiting the range of (f4-f5)/CP4 may improve the yield of the optical imaging lens assembly. Preferably, 7.59≤(f4-f5)/CP4≤22.64.

In this embodiment, a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, the second lens has the largest refractive index in all of the lenses of the optical imaging lens assembly, and R3 is a curvature radius of an object-side surface of the second lens, R4 is a curvature radius of an image-side surface of the second lens, CP1 is a thickness of the first spacer, and CP2 is a thickness of the second spacer, R3 and R4 and CP1 and CP2 satisfy −10<R3/R4+CP1/CP2<5. The use of a high refractive index material for the second lens may reduce a chromatic aberration of the optical imaging lens assembly and improve the imaging quality. Moreover, curvatures of the object-side surface and the image-side surface of the second lens are reduced, such that the workability of the second lens is improved, and the yield is improved. Furthermore, the uniformity of the thicknesses of the first spacer, the second lens and the second spacer is significantly improved, such that the stability of the optical imaging lens assembly is improved, and the yield of the optical imaging lens assembly is further improved. Preferably, −7<R3/R4+CP1/CP2<5. Further preferably, −6.86≤R3/R4+CP1/CP2≤4.17.

In this embodiment, TD is an on-axis distance from the object-side surface of the first lens to the image-side surface of the fifth lens, and ΣCP is a sum of thicknesses of all of the spacers, TD and ΣCP satisfy 3<TD/ΣCP<8. By controlling TD/ΣCP within a reasonable range, the center thicknesses of all of the lenses and the thicknesses of all of the spacers are guaranteed to fall within a reasonable range, such that it is guaranteed that the lens is formed without forming defects of molding sink marks and bright lines at a transition portion caused by too large center thickness and too small transition portion of the mechanism portion, so as to avoid generating stray light and then reducing the imaging effect, and the yield of the optical imaging lens assembly is improved. Serious deformation of the lenses caused by too thin center thickness is avoided during assembly, and the situation that a curve of a surface type of the lens seriously deviates from design requirements and then the lens resolution is reduced is avoided, such that the yield of the optical imaging lens assembly is guaranteed. Preferably, 3.23≤TD/ΣCP≤7.17.

In this embodiment, a spacer of the plurality of spacers located on an image side of the first lens and abutting against the image-side surface of the first lens is a first spacer, a spacer of the plurality of spacers located on an image side of the second lens and abutting against an image-side surface of the second lens is a second spacer, a spacer of the plurality of spacers located on an image side of the third lens and abutting against an image-side surface of the third lens is a third spacer, and f is an effective focal length of the optical imaging lens assembly, CP1 is a thickness of the first spacer, CP2 is a thickness of the second spacer, CP3 is a thickness of the third spacer, and CP4 is a thickness of the fourth spacer, T34 and T45 and CT4 and CP3 and CP4 satisfy 0<f/(CP1+CP2+CP3+CP4)<10. By controlling f/(CP1+CP2+CP3+CP4) within a reasonable range, the effective focal length of the optical imaging lens assembly is able to be guaranteed to fall within a reasonable range, which helps to improve the stability of forming and assembly of the lenses in the optical imaging lens assembly and improve the yield of the optical imaging lens assembly. Moreover, the situation that the spacer is too thick or too thin, resulting in unstable assembly is avoided, and the situation that the gap consistency of the optical imaging lens assembly is poor, resulting in poor imaging effect, thus reducing the reliability of the lens is avoided. Furthermore, the problem of spacer deformation or surface brightening is able to be solved, to improve the yield of the optical imaging lens assembly, and the risk of stray light may also be reduced, to improve the imaging effect. Preferably, 3.27 sf/(CP1+CP2+CP3+CP4)≤8.24.

In this embodiment, when an image-side surface of an ith lens and an object-side surface of an (i+1)th lens are concave surfaces, T(i, i+1) is an on-axis distance between the image-side surface of the ith lens and the object-side surface of the (i+1)th lens, and CPi is a thickness of an ith spacer satisfy 0<T(i, i+1)/CPi<25, wherein the ith spacer is a spacer of the plurality of spacers located on an image side of the ith lens and abutting against the image-side surface of the ith lens, and i is able to be 1, 2, 3 and 4. By controlling T(i,i+1)/CPi within a reasonable range, a gap between concave surfaces of two adjacent lenses is able to be guaranteed to fall within a reasonable range, such that the balance between the thicknesses of the lenses and the gap is able to be guaranteed, and the stability of assembly of the optical imaging lens assembly is able to be improved. Furthermore, the thickness of the spacer between the two adjacent lenses is able to be further guaranteed to fall within a reasonable range, so as to solve the problem of stray light caused by the deformation of the too thin spacer, and guarantee the imaging quality.

In this embodiment, at least two of the first lens to the fifth lens have positive refractive powers. At least two of the lenses have positive refractive powers, facilitating light convergence, reducing the total length of the optical imaging lens assembly, and facilitating miniaturization of the optical imaging lens assembly.

In this embodiment, the first lens has a positive refractive power, the fourth lens has a positive refractive power, and the fifth lens has a negative refractive power. The first lens is designed to have a positive refractive power to facilitate light convergence, such that light may smoothly enter a rear optical system, to reduce the total length of the optical imaging lens assembly. The fourth lens is designed to have a positive refractive power to further concentrate the light, so as to reduce the total length of the optical imaging lens assembly. The fifth lens is designed to have a negative refractive power to diffuse the light, to achieve a function of a large image plane.

In this embodiment, the first lens is a meniscus lens having a convex object-side surface, to cooperate with the positive refractive power of the first lens, such that it is advantageous to concentrate light, reduce an aberration such as a spherical aberration and improve the imaging quality.

In this embodiment, a refractive index of at least one lens of the optical imaging lens assembly is greater than that of the first lens. Since the refractive index of the first lens is not the maximum refractive index, in the case of a certain center thickness, an edge thickness is not too thin, so as to guarantee processing forming of the first lens and the yield of the optical imaging lens assembly.

In this embodiment, f1 is an effective focal length of the first lens, f2 is an effective focal length of the second lens, and f3 is an effective focal length of the third lens, f1 and f2 and f3 satisfy |f1|<|f2|<|f3|. By controlling |f1|<|f2|<|f3| within a reasonable range, the curvature of the first lens is able to be guaranteed to be greater than that of the second lens, and the curvature of the second lens is able to be guaranteed to be greater than that of the third lens, so as to reduce a head size of a front small-camera lens, improve a screen-to-body ratio of a lens carrier apparatus such as a mobile phone and improve user experience.

### Embodiment 2

As shown in FIGS. 1-22, the optical imaging lens assembly includes a lens barrel P0, wherein the lens barrel P0 is internally provided with a first lens; a second lens; a third lens; a fourth lens, wherein the fourth lens has a positive refractive power; a fifth lens, wherein the fifth lens has the largest outer diameter in all of the lenses of the optical imaging lens assembly; and a plurality of spacers, wherein the plurality of spacers at least include a third spacer and a fourth spacer, the third spacer is located on an image side of the third lens and abuts against an image-side surface of the third lens, the fourth spacer is located on an image side of the fourth lens and abuts against an image-side surface of the fourth lens, and the fourth spacer is thicker than the remaining spacers; wherein T34 is an on-axis distance from the image-side surface of the third lens to an object-side surface of the fourth lens, CT4 is a center thickness of the fourth lens, T45 is an on-axis distance from the image-side surface of the fourth lens to an object-side surface of the fifth lens, CP3 is a thickness of the third spacer, and CP4 is a thickness of the fourth spacer, T34 and T45 and CT4 and CP3 and CP4 satisfy 1<(T34+CT4+T45)/(CP3+CP4)<5.

The fifth lens has the largest outer diameter in all of the lenses of the optical imaging lens assembly, such that a larger operation space is provided for assembly of a front lens of the small-camera optical imaging lens assembly, to avoid collision of the spacers and the lenses with the lens barrel P0, and a larger operation space is also provided for glue dispensing of the front lens and the spacer, to facilitate flow of glue into a position to be dispensed. The tightness of connection between the lenses and the lens barrel P0 is guaranteed, then the stability during assembly is guaranteed, and the yield of the optical imaging lens assembly is improved. Moreover, (T34+CT4+T45)/(CP3+CP4) is controlled within a reasonable range, to avoid deformation or shaking caused by the third spacer and the fourth spacer being too thin, so as to form a strong support for the front lens, and to guarantee the stability of assembly between the lenses, thereby effectively increasing the yield of the optical imaging lens assembly. Furthermore, a difference between the edge thickness and the center thickness of the third lens, and a difference between an edge thickness and the center thickness of the fourth lens are guaranteed to fall within a controllable range, which helps to improve smoothness of edge transition of the third lens and the fourth lens, such that smooth transition between abutting portions and optically active portions of the third lens and the fourth lens is able to be achieved, avoiding generation of stress concentration regions, processing forming of the third lens and the fourth lens is guaranteed, the yield of the optical imaging lens assembly is improved, and the ability of the optical imaging lens assembly to resist harsh environments is also improved.

Preferably, T34 is an on-axis distance from the image-side surface of the third lens to an object-side surface of the fourth lens, CT4 is a center thickness of the fourth lens, T45 is an on-axis distance from the image-side surface of the fourth lens to an object-side surface of the fifth lens, CP3 is a thickness of the third spacer, and CP4 is a thickness of the fourth spacer satisfy 1.80≤(T34+CT4+T45)/(CP3+CP4)≤4.45.

In this embodiment, a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, and EP12 is a distance between the first spacer and the second spacer, EP23 is a distance between the second spacer and the third spacer, CT2 is a center thickness of the second lens, and CT3 is a center thickness of the third lens, EP12 and CT2 and EP23 and CT3 satisfy 2<EP12/CT2+EP23/CT3<5. By controlling EP12/CT2+EP23/CT3 within a reasonable range, a ratio of an edge thickness to a center thickness of the second lens and the third lens is more reasonable, the risk of appearance defects of the second lens and the third lens is reduced, the forming yield of the second lens and the third lens is greatly improved, and a better coincidence between a surface profile curve of an optically active portion of the lens and a design value is able to be achieved, such that resolution of the optical imaging lens assembly is closer to the design value, and the imaging effect is improved. Preferably, 2.68≤EP12/CT2+EP23/CT3≤3.92.

In this embodiment, a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, and EP12 is a distance between the first spacer and the second spacer, EP23 is a distance between the second spacer and the third spacer, f1 is an effective focal length of the first lens, and f2 is an effective focal length of the second lens, f1 and EP12 and f2 and EP23 satisfy −25<f1/EP12+f2/EP23<0. By controlling f1/EP12+f2/EP23 within a reasonable range, it is able to be guaranteed that after light passes through the first lens and the second lens, an entire image height increases. Furthermore, by controlling distances between the first spacer, the second spacer and the third spacer, image height matching with a chip are able to be satisfied while a length of the lens barrel P0 is reduced, such that a structure of the optical imaging lens assembly is more compact, which is conducive to reducing the size of the optical imaging lens assembly and saving space for a carrier apparatus. Preferably, −23.96≤f1/EP12+f2/EP23≤−4.22.

In this embodiment, a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, the second lens has the smallest center thickness in all of the lenses of the optical imaging lens assembly, and CP1 is a thickness of the first spacer, EP12 is a distance between the first spacer and the second spacer, CP2 is a thickness of the second spacer, and CT2 is a center thickness of the second lens, CP1 and EP12 and CP2 satisfy 1<(CP1+EP12+CP2)/CT2<4. By controlling (CP1+EP12+CP2)/CT2 within a reasonable range, a ratio of the center thickness to the edge thickness of the second lens is able to be guaranteed to fall within a reasonable range, the center thickness and the edge thickness of the second lens are able to be guaranteed to be uniform, processability of the second lens is able to be guaranteed, the manufacturing yield of the second lens is able to be improved, and then the assembly yield of the optical imaging lens assembly is able to be improved. The stability of formation and assembly of the first spacer, the second lens and the second spacer may also be guaranteed, to avoid deformation of the spacer, and to guarantee the yield of the optical imaging lens assembly. Furthermore, a resolution performance of the optical imaging lens assembly is able to be significantly improved in extreme environments such as high temperature and humidity. Preferably, 1.98≤(CP1+EP12+CP2)/CT2≤3.20.

In this embodiment, a spacer of the plurality of spacers located on an image side of the second lens and abutting against an image-side surface of the second lens is a second spacer, and f3 is an effective focal length of the third lens, EP23 is a distance between the second spacer and the third spacer, f4 is an effective focal length of the fourth lens, and EP34 is a distance between the third spacer and the fourth spacer, f3 and EP23 and f4 and EP34 satisfy −70<f3/EP23+f4/EP34<80. By controlling f3/EP23+f4/EP34 within a reasonable range, ratios of the focal lengths to the edge thicknesses of the third lens and the fourth lens fall within a controllable range, and the bending degree and the edge thickness of the lenses fall within a controllable range, such that the risk of producing weld lines during injection molding of the lens is able to be significantly reduced, the formability of the third lens and the fourth lens is improved, and the yield of the optical imaging lens assembly is improved. Preferably, −66.20≤f3/EP23+f4/EP34≤72.53.

In this embodiment, the optical imaging lens assembly further includes a fourth auxiliary spacer located on an image side of the fourth spacer and abutting against an image-side surface of the fourth spacer, wherein CP4 is a thickness of the fourth spacer, CP4b is a thickness of the fourth auxiliary spacer, and T45 is an on-axis distance from the image-side surface of the fourth lens to an object-side surface of the fifth lens, CP4 and CP4b and T45 satisfy 0<(CP4+CP4b)/T45<11. Arrangement of the fourth auxiliary spacer helps to avoid stray light generated from an inner surface of the fourth spacer, so as to enhance the imaging effect. Furthermore, by controlling (CP4+CP4b)/T45 within a reasonable range, a large gap of the structural portions of the fourth lens and the fifth lens is able to be rationally distributed on two spacers, to guarantee the stability of assembly of the large gap position, and improve the yield of the optical imaging lens assembly. Preferably, 0.48≤(CP4+CP4b)/T45≤10.81.

In this embodiment, f4 is an effective focal length of the fourth lens, f5 is an effective focal length of the fifth lens, and CP4 is a center thickness of the fourth lens, f4 and f5 and CP4 satisfy 5<(f4-f5)/CP4<25. By controlling (f4-f5)/CP4 within a reasonable range, an excessive gap between an edge of the fourth lens and an edge of the fifth lens is able to be effectively reduced, so as to avoid unstable assembly and abutting of the fourth lens and the fifth lens. The situation of direct abutting of two lenses may further be avoided when the gap is too small. Since there is a large difference in apertures of the fourth lens and the fifth lens, direct abutting of the two lenses may cause a risk of deformation and fracturing of the fourth lens, such that limiting the range of (f4-f5)/CP4 may improve the yield of the optical imaging lens assembly. Preferably, 7.59≤(f4-f5)/CP4≤22.64.

In this embodiment, a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, the second lens has the largest refractive index in all of the lenses of the optical imaging lens assembly, and R3 is a curvature radius of an object-side surface of the second lens, R4 is a curvature radius of an image-side surface of the second lens, CP1 is a thickness of the first spacer, and CP2 is a thickness of the second spacer, R3 and R4 and CP1 and CP2 satisfy −10<R3/R4+CP1/CP2<5. The use of a high refractive index material for the second lens may reduce a chromatic aberration of the optical imaging lens assembly and improve the imaging quality. Moreover, curvatures of the object-side surface and the image-side surface of the second lens are reduced, such that the workability of the second lens is improved, and the yield is improved. Furthermore, the uniformity of the thicknesses of the first spacer, the second lens and the second spacer is significantly improved, such that the stability of the optical imaging lens assembly is improved, and the yield of the optical imaging lens assembly is further improved. Preferably, −7<R3/R4+CP1/CP2<5. Further preferably, −6.86≤R3/R4+CP1/CP2≤4.17.

In this embodiment, TD is an on-axis distance from the object-side surface of the first lens to the image-side surface of the fifth lens, and ΣCP is a sum of thicknesses of all of the spacers, TD and ΣCP satisfy 3<TD/ΣCP<8. By controlling TD/ΣCP within a reasonable range, the center thicknesses of all of the lenses and the thicknesses of all of the spacers are guaranteed to fall within a reasonable range, such that it is guaranteed that the lens is formed without forming defects of molding sink marks and bright lines at a transition portion caused by too large center thickness and too small transition portion of the mechanism portion, so as to avoid generating stray light and then reducing the imaging effect, and the yield of the optical imaging lens assembly is improved. Serious deformation of the lenses caused by too thin center thickness is avoided during assembly, and the situation that a curve of a surface type of the lens seriously deviates from design requirements and then the lens resolution is reduced is avoided, such that the yield of the optical imaging lens assembly is guaranteed. Preferably, 3.23≤TD/ΣCP≤7.17.

In this embodiment, a spacer of the plurality of spacers located on an image side of the first lens and abutting against the image-side surface of the first lens is a first spacer, a spacer of the plurality of spacers located on an image side of the second lens and abutting against an image-side surface of the second lens is a second spacer, and f is an effective focal length of the optical imaging lens assembly, CP1 is a thickness of the first spacer, CP2 is a thickness of the second spacer, CP3 is a thickness of the third spacer, and CP4 is a thickness of the fourth spacer, f and CP1 and CP2 and CP3 and CP4 satisfy 0<f/(CP1+CP2+CP3+CP4)<10. By controlling f/(CP1+CP2+CP3+CP4) within a reasonable range, the effective focal length of the optical imaging lens assembly is able to be guaranteed to fall within a reasonable range, which helps to improve the stability of forming and assembly of the lenses in the optical imaging lens assembly and improve the yield of the optical imaging lens assembly. Moreover, the situation that the spacer is too thick or too thin, resulting in unstable assembly is avoided, and the situation that the gap consistency of the optical imaging lens assembly is poor, resulting in poor imaging effect, thus reducing the reliability of the lens is avoided. Furthermore, the problem of spacer deformation or surface brightening is able to be solved, to improve the yield of the optical imaging lens assembly, and the risk of stray light may also be reduced, to improve the imaging effect. Preferably, 3.27sf/(CP1+CP2+CP3+CP4)≤8.24.

In this embodiment, when an image-side surface of an ith lens and an object-side surface of an (i+1)th lens are concave surfaces, T(i, i+1) is an on-axis distance between the image-side surface of the ith lens and the object-side surface of the (i+1)th lens, and CPi is a thickness of an ith spacer, T(i, i+1) and CPi satisfy 0<T(i, i+1)/CPi<25, wherein the ith spacer is a spacer of the plurality of spacers located on an image side of the ith lens and abutting against the image-side surface of the ith lens, and i is able to be 1, 2, 3 and 4. By controlling T(i,i+1)/CPi within a reasonable range, a gap between concave surfaces of two adjacent lenses is able to be guaranteed to fall within a reasonable range, such that the balance between the thicknesses of the lenses and the gap is able to be guaranteed, and the stability of assembly of the optical imaging lens assembly is able to be improved. Furthermore, the thickness of the spacers between the two adjacent lenses is able to be further guaranteed to fall within a reasonable range, so as to solve the problem of stray light caused by the deformation of the too thin spacer, and guarantee the imaging quality.

In this embodiment, at least two of the first lens to the fifth lens have positive refractive powers. At least two of the lenses have positive refractive powers, facilitating light convergence, reducing the total length of the optical imaging lens assembly, and facilitating miniaturization of the optical imaging lens assembly.

In this embodiment, the first lens has a positive refractive power, the fourth lens has a positive refractive power, and the fifth lens has a negative refractive power. The first lens is designed to have a positive refractive power to facilitate light convergence, such that light may smoothly enter a rear optical system, to reduce the total length of the optical imaging lens assembly. The fourth lens is designed to have a positive refractive power to further concentrate the light, so as to reduce the total length of the optical imaging lens assembly. The fifth lens is designed to have a negative refractive power to diffuse the light, to achieve a function of a large image plane.

In this embodiment, the first lens is a meniscus lens having a convex object-side surface, to cooperate with the positive refractive power of the first lens, such that it is advantageous to concentrate light, reduce an aberration such as a spherical aberration and improve the imaging quality.

In this embodiment, a refractive index of at least one lens of the optical imaging lens assembly is greater than that of the first lens. Since the refractive index of the first lens is not the maximum refractive index, in the case of a certain center thickness, an edge thickness is not too thin, so as to guarantee processing forming of the first lens and the yield of the optical imaging lens assembly.

In this embodiment, f1 is an effective focal length of the first lens, f2 is an effective focal length of the second lens, and f3 is an effective focal length of the third lens, f1 and f2 and f3 satisfy |f1|<|f2|<|f3|. By controlling |f1|<|f2|<|f3| within a reasonable range, the curvature of the first lens is able to be guaranteed to be greater than that of the second lens, and the curvature of the second lens is able to be guaranteed to be greater than that of the third lens, so as to reduce a head size of a front small-camera lens, improve a screen-to-body ratio of a lens carrier apparatus such as a mobile phone and improve user experience.

Optionally, the above optical imaging lens assembly may further include a filter used for correcting color deviation. And the optical imaging lens assembly may further include a protective glass used for protecting a photosensitive element located on an imaging surface.

The optical imaging lens assembly according to the disclosure may employ a plurality of lenses, for example, five lenses described above. The refractive power and a surface type of each lens, the center thickness of each lens, the on-axis distance between the lenses, etc. are reasonably distributed, thereby effectively increasing an aperture of the optical imaging lens assembly, reducing sensitivity of the lens, and improving machinability of the lens, which makes the optical imaging lens assembly more beneficial to production and processing and suitable for portable electronic apparatuses such as smart phones.

In the disclosure, at least one of mirror surfaces of each lens is an aspheric mirror surface. The aspheric lens is characterized in that the curvature is continuously changed from a center of the lens to a periphery of the lens. Different from a spherical lens with a constant curvature from the center of the lens to the periphery of the lens, the aspheric lens has a better feature of a curvature radius and has the advantages of improving distortion aberration and astigmatism aberration. After the aspheric lens is used, aberration occurring during imaging is able to be eliminated as much as possible, thereby improving the imaging quality.

However, it should be understood by those skilled in the art that the number of lenses constituting the optical imaging lens assembly may be varied to obtain various results and advantages described in this specification without departing from the claimed technical solution of the disclosure. For example, although described with five lenses as an example in implementation modes, the optical imaging lens assembly is not limited to including five lenses. The optical imaging lens assembly may also include other numbers of lenses if desired.

FIG. 1 is a schematic structural diagram of an optical imaging lens assembly according to the disclosure. d0s, CP4, EP12 and other parameters are also indicated in FIG. 1, so as to clearly and intuitively understand the meaning of the parameters. Since the fifth lens has the largest outer diameter in the optical imaging lens assembly of the disclosure, an inner diameter and an outer diameter of an image-side end surface of the lens barrel P0 are larger, and the head of the optical imaging lens assembly of the disclosure is smaller, facilitating mounting of the front end lens and the spacer, such that the yield of the optical imaging lens assembly is improved. In order to present the structure of the optical imaging lens assembly and particular surface types, these parameters will not be presented in the drawings when particular examples are subsequently described.

d0s is an inner diameter of an object-side end surface of the lens barrel P0, D0s is an outer diameter of the object-side end surface of the lens barrel P0, d0m is the inner diameter of the image-side end surface of the lens barrel P0, D0m is the outer diameter of the image-side end surface of the lens barrel P0, L, a total length of the lens barrel P0 is a distance from the object-side end surface to the image-side end surface of the lens barrel P0, and EPij refers to a distance along an optical axis between an image-side surface of the ith spacer and an object-side surface of the jth spacer, wherein i is less than j, i takes a value from 1, 2 and 3, and j takes a value from 2, 3 and 4.

Examples of particular surface types and parameters that is able to be applied to the optical imaging lens assembly of the above implementation modes are further described below with reference to the drawings.

It is to be noted that there are a first state, a second state, and a third state in the following examples, and parameters of the curvature radius, the center thickness, etc. of the first lens, the second lens, the third lens, the fourth lens, and the fifth lens of the optical imaging lens assembly, spacing distances between the lenses, and higher order image coefficients in the first state, the second state, and the third state in the same example are the same, but the parameters of the lens barrel P0, thicknesses of the spacers, inner diameters of the spacers, outer diameters of the spacers, and distances between the spacers are different, and the shapes of some of the lenses are different. Or a primary structure for imaging is the same, while a secondary structure for imaging is different.

It is to be noted that any one of the following Examples 1-3 is applicable to all embodiments of the disclosure.

### Example 1

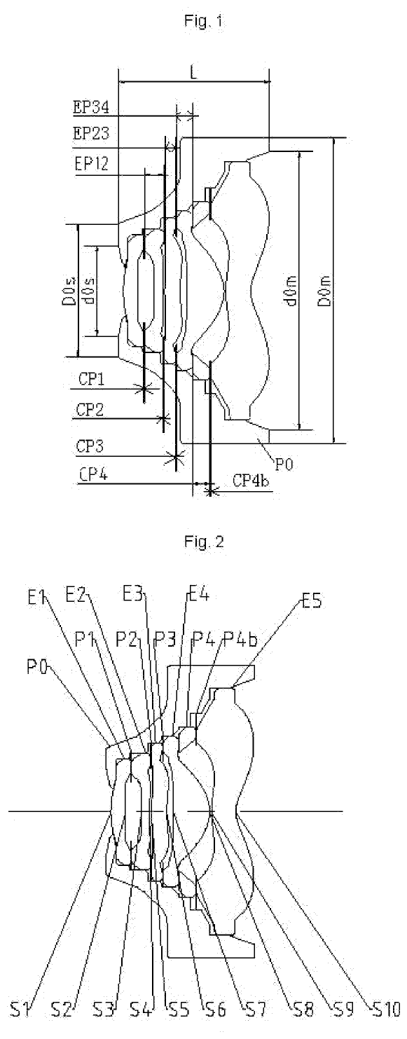

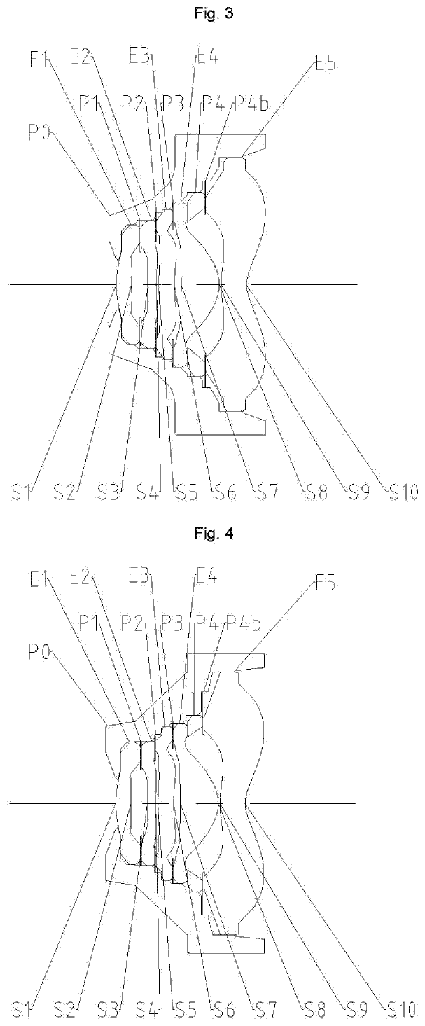

As shown in FIGS. 2-8, an optical imaging lens assembly according to Example 1 of the disclosure is described. FIG. 2 is a schematic structural diagram of the optical imaging lens assembly in a first state according to Example 1. FIG. 3 is a schematic structural diagram of the optical imaging lens assembly in a second state according to Example 1. FIG. 4 is a schematic structural diagram of the optical imaging lens assembly in a third state according to Example 1.

As shown in FIGS. 2-4, the optical imaging lens assembly sequentially includes, from an object side to an image side: a first lens E1, a first spacer P1, a second lens E2, a second spacer P2, a third lens E3, a third spacer P3, a fourth lens E4, a fourth spacer P4, a fourth auxiliary spacer P4b, and a fifth lens E5.

In FIGS. 2-4, both the first lens E1 and the second lens E2 abut against the first spacer P2. Both the second lens E2 and the third lens E3 abut against the second spacer P2. Both the third lens E3 and the fourth lens E4 abut against the third spacer P3. Two spacers are arranged between the fourth lens E4 and the fifth lens E5, to achieve a first-step step height arrangement, so as to facilitate stable abutting of the structures. Inner diameters of object-side surfaces of the first spacer, the second spacer, and the third spacer are sequentially increased to facilitate reduction in the head of the optical imaging lens assembly and interception of stray light reflected back behind. An inner diameter of an object-side surface of the fourth auxiliary spacer is less than an outer diameter of an image-side surface of the third spacer, such that the fourth auxiliary spacer shares a larger step height, to make a profile of the thicker fourth spacer smoother, and further to improve the processing yield of the fourth spacer. The inner diameter of the object-side surface of the fourth auxiliary spacer is less than an inner diameter of an image-side surface of the fourth spacer, to intercept stray light reflected from an inner diameter surface of the fourth spacer, and further to improve imaging quality. An abutting area of the image-side surface of the fourth auxiliary spacer and an object-side surface of the fifth lens is greater than that of the object-side surface of the fourth auxiliary spacer and the image-side surface of the fourth spacer, to enhance the stability during abutting of the fifth lens.

An object-side surface S1 of the first lens is a convex surface, and an image-side surface S2 of the first lens is a concave surface. An object-side surface S3 of the second lens is a convex surface, and an image-side surface S4 of the second lens is a concave surface. An object-side surface S5 of the third lens is a convex surface, and an image-side surface S6 of the third lens is a concave surface. An object-side surface S7 of the fourth lens is a concave surface, and an image-side surface S8 of the fourth lens is a convex surface. An object-side surface S9 of the fifth lens is a convex surface, and an image-side surface S10 of the fifth lens is a concave surface.

In this example, f is an effective focal length of the optical imaging lens assembly, f is 3.76 mm, and Semi-FOV is a half of a field of view, Semi-FOV is 48.75°. The image-side surface S6 of the third lens and the object-side surface S7 of the fourth lens are concave surfaces. Preferably, 8.52≤T34/CP3≤12.78.

In this example, in the first state, EP23<EP34<EP12, the fourth spacer has the largest thickness, and the first spacer, the second spacer, the third spacer, and the fourth auxiliary spacer have equal thicknesses. In the second state, EP34<EP12<EP23, the fourth spacer has the largest thickness, the first spacer has a larger thickness than that of the second spacer, the second spacer and the third spacer have equal thicknesses, and the first spacer and the fourth auxiliary spacer have equal thicknesses. In the third state, EP34<EP12<EP23, the fourth spacer has the largest thickness, the first spacer has a larger thickness than that of the second spacer, the second spacer and the third spacer have equal thicknesses, and the first spacer and the fourth auxiliary spacer have equal thicknesses. The thicknesses of some thinner spacers are set to be the same, to facilitate production processing of each spacer.

Table 1 illustrates a table of basic structural parameters of the optical imaging lens assembly of Example 1, wherein the units of the curvature radius, the thickness/distance, and the effective radius are millimeters (mm).

TABLE 1

| Surface | Surface | Curvature | | Material | | |
|---|---|---|---|---|---|---|
| number | type | radius | Thickness | Refractive | Abbe | |
| OBJ | Spherical | Infinity | 450 | index | number | Effective radius |
| STO | Spherical | Infinity | −0.0788 | | | |
| S1 | Aspheric | 3.3225 | 0.5651 | 1.54 | 56.00 | 0.8706 |
| S2 | Aspheric | 16.1122 | 0.6115 | | | 0.9805 |
| S3 | Aspheric | 18.0526 | 0.3077 | 1.67 | 19.20 | 1.2254 |
| S4 | Aspheric | 6.3742 | 0.0801 | | | 1.4885 |
| S5 | Aspheric | 4.2047 | 0.5894 | 1.54 | 56.10 | 1.6882 |
| S6 | Aspheric | 5.4123 | 0.2557 | | | 1.8828 |
| S7 | Aspheric | −8.6455 | 1.4114 | 1.54 | 56.00 | 2.0272 |
| S8 | Aspheric | −1.1816 | 0.0648 | | | 2.1680 |
| S9 | Aspheric | 3.6374 | 0.9391 | 1.64 | 23.50 | 2.5578 |
| S10 | Aspheric | 1.0856 | 0.7268 | | | 3.7732 |
| S11 | Spherical | Infinity | 0.2100 | 1.52 | 64.20 | 4.0576 |
| S12 | Spherical | Infinity | 0.5634 | | | 4.1395 |
| S13 | Spherical | Infinity | | | | |

In Example 1, both of the object-side surface and the image-side surface of any one of the first lens E1 to the fifth lens E5 are aspheric surfaces, and the surface type of each aspheric lens is able to be defined by, but is not limited to, the following aspheric formula:

$$x = \frac{{ch}^{2}}{1 + \sqrt{1 - ( k + 1 ) {c}^{2} {h}^{2}}} + \sum {Aih}^{i} ; \qquad ( 1 )$$

wherein x is a vector height of a distance between the aspheric surface and a vertex of the aspheric surface when the aspheric surface is located at a position with the height h in the optical axis direction; c is a paraxial curvature of the aspheric surface, c=1/R, that is, the paraxial curvature c is an inverse of curvature radius R in Table 1 above; k is a conic coefficient; and Ai is a correction coefficient of the i-th order of the aspheric surface. Table 2 below shows higher order term coefficients A4, A6, A8, A10, A12, A14, A16, A18, A20, A22, A24, A26, A28 and A30 that is able to be used for each of the aspheric mirror surfaces S1-S10 in Example 1.

TABLE 2

| Surface number | A4 | A6 | A8 | A10 | A12 | A14 | A16 |
|---|---|---|---|---|---|---|---|
| S1 | −3.2868E−02 | 5.8371E−01 | −9.6669E+00 | 9.8350E+01 | −6.6631E+02 | 3.1300E+03 | −1.0443E+04 |
| S2 | −2.4074E−02 | −1.5206E−01 | 1.0391E+00 | −1.4685E+00 | −3.2984E+01 | 2.8642E+02 | −1.2240E+03 |
| S3 | −5.2205E−02 | 1.7524E−01 | −1.5594E+00 | 7.3214E+00 | −2.2577E+01 | 4.7532E+01 | −7.0191E+01 |
| S4 | −2.9453E−02 | −7.5169E−02 | 2.0313E−02 | 4.9101E−01 | −1.4324E+00 | 2.0056E+00 | −1.5446E+00 |
| S5 | −4.9204E−02 | −1.4377E−01 | 2.7871E−01 | −3.0434E−01 | 3.7789E−01 | −5.9643E−01 | 7.7068E−01 |
| S6 | 3.7047E−02 | −1.6717E−01 | 2.6639E−01 | −3.7911E−01 | 4.6491E−01 | −4.6549E−01 | 3.6818E−01 |
| S7 | 9.7348E−02 | −1.1862E−01 | 1.1586E−01 | −8.9682E−02 | 5.9716E−02 | −5.2570E−02 | 5.1735E−02 |
| S8 | 2.2505E−01 | −4.9430E−01 | 8.3168E−01 | −9.7927E−01 | 8.0929E−01 | −4.6954E−01 | 1.8811E−01 |
| S9 | 5.6070E−02 | −3.4673E−01 | 5.8128E−01 | −6.2363E−01 | 4.6761E−01 | −2.5381E−01 | 1.0130E−01 |
| S10 | −2.6363E−01 | 1.7062E−01 | −9.4531E−02 | 4.0012E−02 | −1.2620E−02 | 2.9492E−03 | −5.1009E−04 |
| Surface number | A18 | A20 | A22 | A24 | A26 | A28 | A30 |
| S1 | 2.5032E+04 | −4.3133E+04 | 5.2813E+04 | −4.4698E+04 | 2.4772E+04 | −8.0563E+03 | 1.1598E+03 |
| S2 | 3.2945E+03 | −5.9737E+03 | 7.4264E+03 | −6.2563E+03 | 3.4180E+03 | −1.0934E+03 | 1.5553E+02 |
| S3 | 7.3514E+01 | −5.4377E+01 | 2.7784E+01 | −9.3316E+00 | 1.8541E+00 | −1.6521E−01 | 0.0000E+00 |
| S4 | 4.8599E−01 | 2.4363E−01 | −3.5469E−01 | 1.8752E−01 | −5.4786E−02 | 8.7471E−03 | −5.9915E−04 |
| S5 | −6.9003E−01 | 4.2298E−01 | −1.7807E−01 | 5.0795E−02 | −9.3995E−03 | 1.0194E−03 | −4.9213E−05 |
| S6 | −2.2475E−01 | 1.0322E−01 | −3.4610E−02 | 8.1543E−03 | −1.2727E−03 | 1.1780E−04 | −4.8857E−06 |
| S7 | −3.7729E−02 | 1.8237E−02 | −5.7859E−03 | 1.1941E−03 | −1.5455E−04 | 1.1402E−05 | −3.6600E−07 |
| S8 | −4.9475E−02 | 7.2531E−03 | −8.0691E−05 | −1.8869E−04 | 3.6525E−05 | −3.0698E−06 | 1.0190E−07 |
| S9 | −2.9873E−02 | 6.4815E−03 | −1.0198E−03 | 1.1301E−04 | −8.3524E−06 | 3.6917E−07 | −7.3745E−09 |
| S10 | 6.5139E−05 | −6.0973E−06 | 4.1184E−07 | −1.9491E−08 | 6.1217E−10 | −1.1445E−11 | 9.6299E−14 |

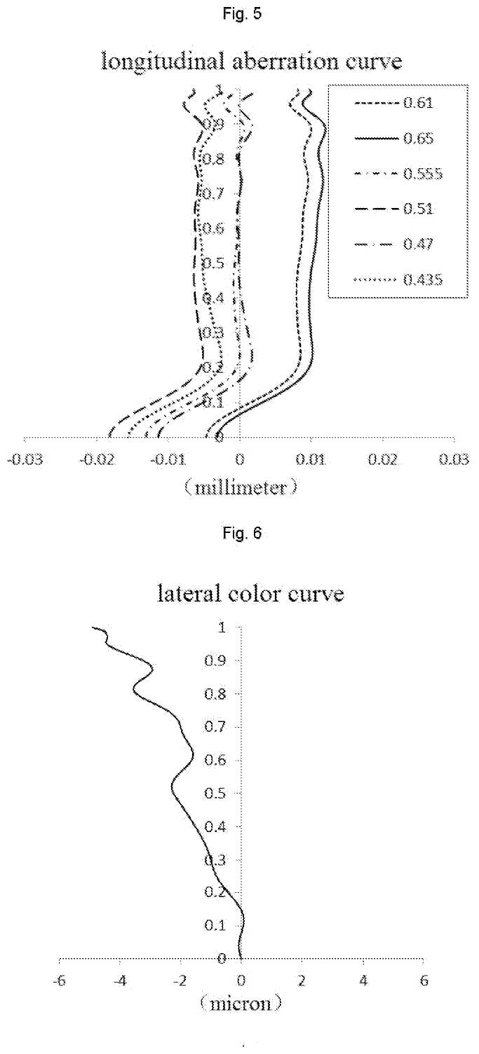

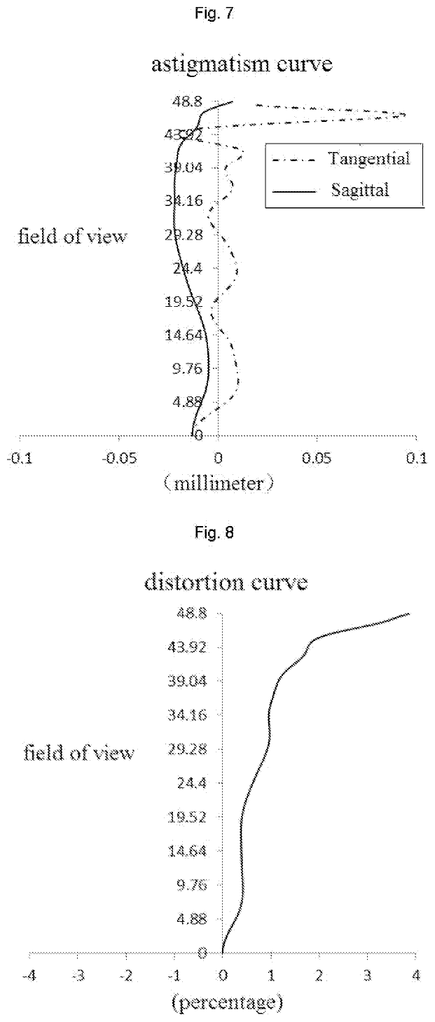

FIG. 5 illustrates a longitudinal chromatic aberration curve of the optical imaging lens assembly in Example 1, which shows that a convergence focus of light rays of different wavelengths is deviated after the light rays pass through the optical imaging lens assembly. FIG. 6 illustrates a lateral color curve of the optical imaging lens assembly in Example 1, which shows a deviation of different image heights of the light rays on the imaging surface after the light rays pass through the optical imaging lens assembly. FIG. 7 illustrates an astigmatism curve of the optical imaging lens assembly in Example 1, which shows a curvature of tangential image surface and a curvature of sagittal image surface. FIG. 8 illustrates a distortion curve of the optical imaging lens assembly in Example 1, which shows distortion magnitude values corresponding to different fields of view.

FIGS. 5-8 illustrate that the optical imaging lens assembly provided in Example 1 may achieve desirable imaging quality.

### Example 2

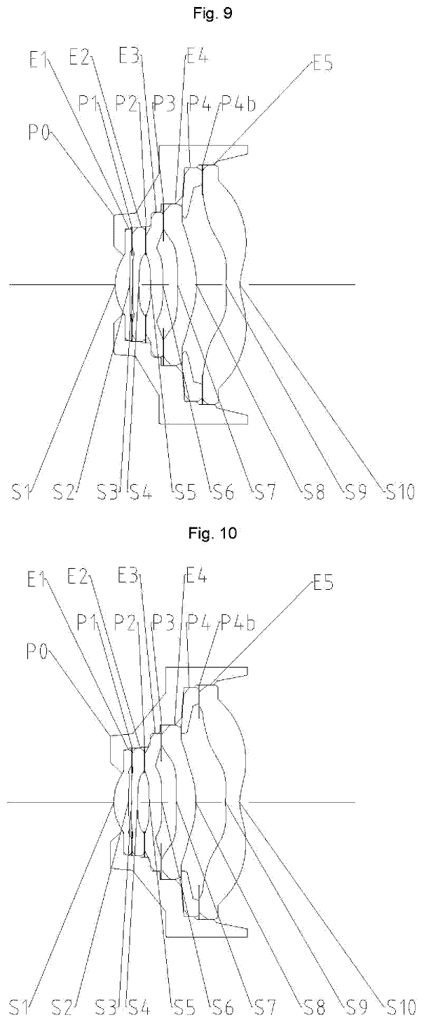

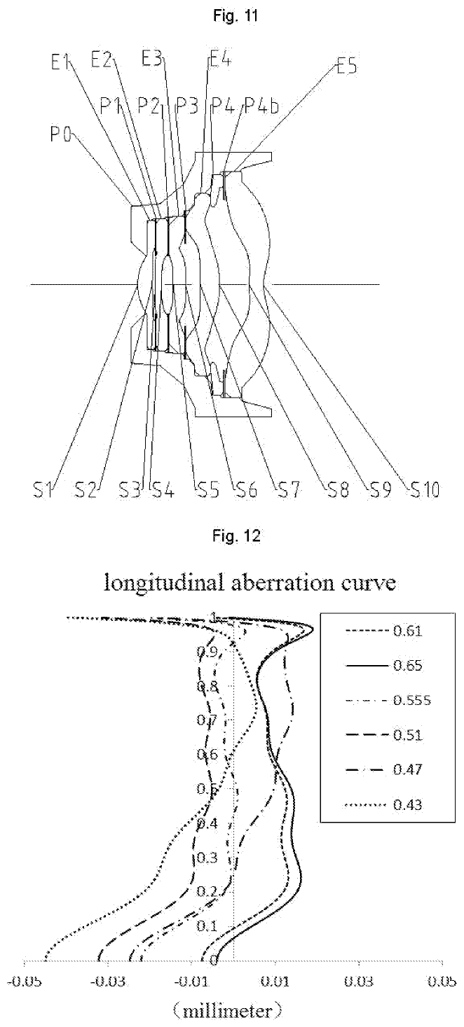

As shown in FIGS. 9-15, an optical imaging lens assembly according to Example 2 of the disclosure is described. FIG. 9 is a schematic structural diagram of the optical imaging lens assembly in a first state according to Example 2. FIG. 10 is a schematic structural diagram of the optical imaging lens assembly in a second state according to Example 2. FIG. 11 is a schematic structural diagram of the optical imaging lens assembly in a third state according to Example 2. Part of the description similar to Example 1 will be omitted for the sake of brevity.

As shown in FIGS. 9-11, the optical imaging lens assembly sequentially includes, from an object side to an image side: a first lens E1, a first spacer P1, a second lens E2, a second spacer P2, a third lens E3, a third spacer P3, a fourth lens E4, a fourth spacer P4, a fourth auxiliary spacer P4b, and a fifth lens E5.

In FIGS. 9-11, both the first lens E1 and the second lens E2 abut against the first spacer P2. Both the second lens E2 and the third lens E3 abut against the second spacer P2. Both the third lens E3 and the fourth lens E4 abut against the third spacer P3. Two spacers are arranged between the fourth lens E4 and the fifth lens E5, to achieve a first-step step height arrangement, so as to facilitate stable abutting of the structures. An inner diameter of an object-side surface of the fourth auxiliary spacer is greater than an outer diameter of an image-side surface of the third spacer, such that the fourth auxiliary spacer shares a larger step height, to make the thicker fourth spacer support lenses on two sides more, and further to improve the stability of assembly. The inner diameter of the object-side surface of the fourth auxiliary spacer is less than an inner diameter of an image-side surface of the fourth spacer, to intercept stray light reflected from an inner diameter surface of the fourth spacer, and further to improve imaging quality. An abutting area of the image-side surface of the fourth auxiliary spacer and an object-side surface of the fifth lens is greater than that of the object-side surface of the fourth auxiliary spacer and the image-side surface of the fourth spacer, to enhance the stability during abutting of the fifth lens.

An object-side surface S1 of the first lens is a convex surface, and an image-side surface S2 of the first lens is a concave surface. An object-side surface S3 of the second lens is a concave surface, and an image-side surface S4 of the second lens is a concave surface. An object-side surface S5 of the third lens is a concave surface, and an image-side surface S6 of the third lens is a concave surface. An object-side surface S7 of the fourth lens is a convex surface, and an image-side surface S8 of the fourth lens is a convex surface. An object-side surface S9 of the fifth lens is a convex surface, and an image-side surface S10 of the fifth lens is a concave surface.

In this example, f is an effective focal length of the optical imaging lens assembly, f is 5.03 mm, and Semi-FOV is a half of a field of view, Semi-FOV is 42.51°. The image-side surface S2 of the first lens and the object-side surface S3 of the second lens are concave surfaces. Preferably, 2.83≤T12/CP1≤5.66. The image-side surface S4 of the second lens and the object-side surface S5 of the third lens are concave surfaces. Preferably, 10.86≤T23/CP2≤21.72.

In this example, EP12<EP23<EP34, the fourth spacer has the largest thickness, and the first spacer, the second spacer, the third spacer, and the fourth auxiliary spacer have equal thicknesses. The thicknesses of some thinner spacers are set to be the same, to facilitate production processing of each spacer.

Table 3 illustrates a table of basic structural parameters of the optical imaging lens assembly of Example 2, wherein the units of the curvature radius, the thickness/distance, and the effective radius are millimeters (mm).

TABLE 3

| Surface | Surface | Curvature | | Material | | |
|---|---|---|---|---|---|---|
| number | type | radius | Thickness | Refractive | Abbe | |
| OBJ | Spherical | Infinity | 450 | index | number | Effective radius |
| STO | Spherical | Infinity | −0.3191 | | | |
| S1 | Aspheric | 1.7767 | 0.5380 | 1.54 | 56.00 | 1.0483 |
| S2 | Aspheric | 8.2069 | 0.1133 | | | 1.0550 |
| S3 | Aspheric | −63.4269 | 0.2289 | 1.67 | 19.20 | 1.0512 |
| S4 | Aspheric | 8.0664 | 0.4345 | | | 1.0065 |
| S5 | Aspheric | −27.5157 | 0.4639 | 1.54 | 56.10 | 1.0863 |
| S6 | Aspheric | 168.7490 | 0.5477 | | | 1.3137 |
| S7 | Aspheric | 314.0193 | 0.7106 | 1.54 | 56.00 | 1.7361 |
| S8 | Aspheric | −3.6331 | 1.0984 | | | 2.1988 |
| S9 | Aspheric | 4.3453 | 0.5273 | 1.54 | 55.70 | 3.2324 |
| S10 | Aspheric | 1.4877 | 0.3430 | | | 3.6806 |
| S11 | Spherical | Infinity | 0.2100 | 1.52 | 64.20 | 4.3369 |
| S12 | Spherical | Infinity | 0.6389 | | | 4.4123 |
| S13 | Spherical | Infinity | | | | |

Table 4 illustrates higher order term coefficients that are able to be used for each aspheric mirror surface S1-S10 in Example 2, wherein each aspheric surface type is able to be defined by Formula 1 given in Example 1 above.

TABLE 4

| Surface number | A4 | A6 | A8 | A10 | A12 | A14 | A16 |
|---|---|---|---|---|---|---|---|
| S1 | −5.1974E−04 | 2.9132E−02 | −1.9225E−01 | 6.5987E−01 | −1.2031E+00 | 6.5604E−01 | 1.6433E+00 |
| S2 | −5.4656E−02 | 4.0825E−02 | −9.7573E−02 | 5.9041E−01 | −2.1624E+00 | 4.6300E+00 | −6.0004E+00 |
| S3 | −5.3723E−02 | 2.9810E−01 | −1.9361E+00 | 1.2635E+01 | −5.5108E+01 | 1.6305E+02 | −3.3513E+02 |
| S4 | −3.1574E−03 | 1.8771E−01 | −1.3595E+00 | 1.4064E+01 | −9.4526E+01 | 4.2154E+02 | −1.2947E+03 |
| S5 | −1.4387E−01 | 5.7690E−01 | −5.6171E+00 | 3.6017E+01 | −1.5674E+02 | 4.7794E+02 | −1.0440E+03 |
| S6 | −1.0915E−01 | 1.5032E−01 | −1.0748E+00 | 5.4177E+00 | −1.8572E+01 | 4.4273E+01 | −7.5029E+01 |
| S7 | −3.8281E−02 | 4.5595E−02 | −2.0447E−01 | 5.8993E−01 | −1.1377E+00 | 1.5006E+00 | −1.3795E+00 |
| S8 | −1.7514E−02 | 2.4188E−02 | −4.3437E−02 | 8.4105E−02 | −1.1596E−01 | 1.1063E−01 | −7.3283E−02 |
| S9 | −2.1555E−01 | 7.8715E−02 | −7.7388E−03 | −1.4470E−02 | 1.2838E−02 | −5.8458E−03 | 1.7211E−03 |
| S10 | −2.4403E−01 | 1.4670E−01 | −7.9302E−02 | 3.5112E−02 | −1.2245E−02 | 3.2897E−03 | −6.7077E−04 |

| Surface number | A18 | A20 | A22 | A24 | A26 | A28 | A30 |
|---|---|---|---|---|---|---|---|
| S1 | −3.8543E+00 | 3.6065E+00 | −1.6601E+00 | 3.0872E−01 | 0.0000E+00 | 0.0000E+00 | 0.0000E+00 |
| S2 | 4.5131E+00 | −1.6786E+00 | 1.1803E−01 | 6.4775E−02 | 0.0000E+00 | 0.0000E+00 | 0.0000E+00 |
| S3 | 4.8076E+02 | −4.7290E+02 | 3.0224E+02 | −1.0796E+02 | 8.6987E+00 | 7.3731E+00 | −1.9429E+00 |
| S4 | 2.7973E+03 | −4.2827E+03 | 4.6179E+03 | −3.4272E+03 | 1.6653E+03 | −4.7673E+02 | 6.0911E+01 |
| S5 | 1.6529E+03 | −1.8989E+03 | 1.5668E+03 | −9.0475E+02 | 3.4707E+02 | −7.9446E+01 | 8.2097E+00 |
| S6 | 9.1505E+01 | −8.0440E+01 | 5.0442E+01 | −2.1976E+01 | 6.3102E+00 | −1.0719E+00 | 8.1424E−02 |
| S7 | 8.9394E−01 | −4.0900E−01 | 1.3075E−01 | −2.8457E−02 | 4.0074E−03 | −3.2885E−04 | 1.1957E−05 |
| S8 | 3.4290E−02 | −1.1466E−02 | 2.7295E−03 | −4.5168E−04 | 4.9313E−05 | −3.1879E−06 | 9.2268E−08 |
| S9 | −3.5025E−04 | 5.0450E−05 | −5.1455E−06 | 3.6412E−07 | −1.7023E−08 | 4.7315E−10 | −5.9236E−12 |
| S10 | 1.0258E−04 | −1.1613E−05 | 9.5523E−07 | −5.5328E−08 | 2.1350E−09 | −4.9195E−11 | 5.1146E−13 |

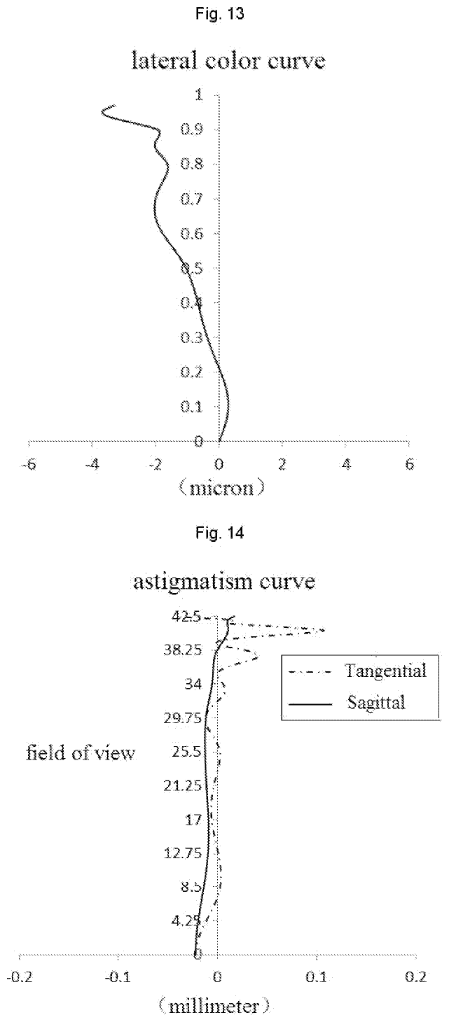

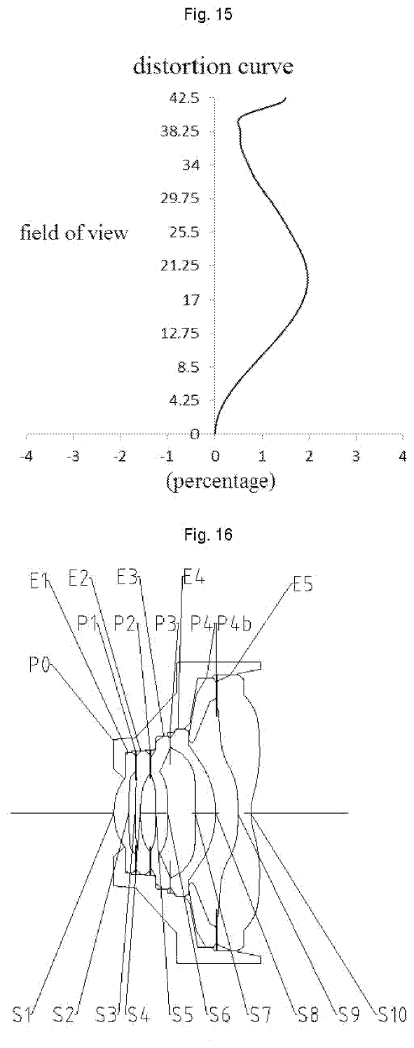

FIG. 12 illustrates a longitudinal chromatic aberration curve of the optical imaging lens assembly in Example 2, which shows that a convergence focus of light rays of different wavelengths is deviated after the light rays pass through the optical imaging lens assembly. FIG. 13 illustrates a lateral color curve of the optical imaging lens assembly in Example 2, which shows a deviation of different image heights of the light rays on the imaging surface after the light rays pass through the optical imaging lens assembly. FIG. 14 illustrates an astigmatism curve of the optical imaging lens assembly in Example 2, which shows a curvature of tangential image surface and a curvature of sagittal image surface. FIG. 15 illustrates a distortion curve of the optical imaging lens assembly in Example 2, which shows distortion magnitude values corresponding to different fields of view.

FIGS. 12-15 illustrate that the optical imaging lens assembly provided in Example 2 may achieve desirable imaging quality.

### Example 3

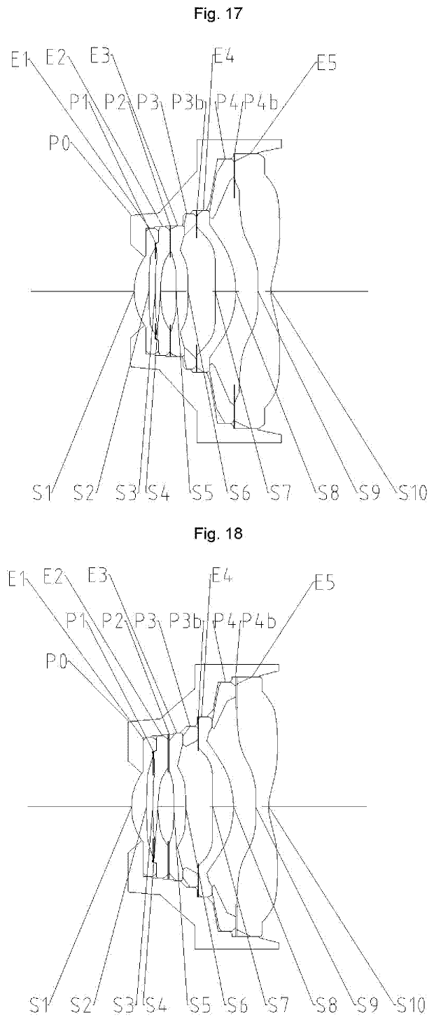

As shown in FIGS. 16-22, an optical imaging lens assembly according to Example 3 of the disclosure is described. FIG. 16 is a schematic structural diagram of the optical imaging lens assembly in a first state according to Example 3. FIG. 17 is a schematic structural diagram of the optical imaging lens assembly in a second state according to Example 3. FIG. 18 is a schematic structural diagram of the optical imaging lens assembly in a third state according to Example 3.

As shown in FIG. 16, the optical imaging lens assembly sequentially includes, from an object side to an image side: a first lens E1, a first spacer P1, a second lens E2, a second spacer P2, a third lens E3, a third spacer P3, a fourth lens E4, a fourth spacer P4, a fourth auxiliary spacer P4b, and a fifth lens E5.

In FIG. 16, both the first lens E1 and the second lens E2 abut against the first spacer P2. Both the second lens E2 and the third lens E3 abut against the second spacer P2. Both the third lens E3 and the fourth lens E4 abut against the third spacer P3. Two spacers are arranged between the fourth lens E4 and the fifth lens E5, to achieve a first-step step height arrangement, so as to facilitate stable abutting of the structures.

As shown in FIGS. 17 and 18, the optical imaging lens assembly sequentially includes, from an object side to an image side: a first lens E1, a first spacer P1, a second lens E2, a second spacer P2, a third lens E3, a third spacer P3, a third auxiliary spacer P3b, a fourth lens E4, a fourth spacer P4, a fourth auxiliary spacer P4b, and a fifth lens E5.

In FIGS. 17 and 18, both the first lens E1 and the second lens E2 abut against the first spacer P2. Both the second lens E2 and the third lens E3 abut against the second spacer P2. Two spacers are arranged between the third lens E3 and the fourth lens E4, to achieve a first-step step height arrangement. Two spacers are arranged between the fourth lens E4 and the fifth lens E5, to achieve a second-step step height arrangement, so as to facilitate stable abutting of the structures. The inner diameter of the object-side surface of the third auxiliary spacer is less than an inner diameter of an image-side surface of the third spacer, to intercept stray light reflected from an inner diameter surface of the third spacer, and further to improve imaging quality. An abutting area of the image-side surface of the third auxiliary spacer and an object-side surface of the fourth lens is greater than that of the object-side surface of the third auxiliary spacer and the image-side surface of the third spacer, to enhance the stability during abutting of the fourth lens.

In FIGS. 16-18, inner diameters of object-side surfaces of the first spacer, the second spacer, and the third spacer are sequentially increased to facilitate reduction in the head of the optical imaging lens assembly and interception of stray light reflected back behind. An inner diameter of an object-side surface of the fourth auxiliary spacer is less than an outer diameter of an image-side surface of the third spacer, such that the fourth auxiliary spacer shares a larger step height, to make a profile of the thicker fourth spacer smoother, and further to improve the processing yield of the fourth spacer. The inner diameter of the object-side surface of the fourth auxiliary spacer is less than an inner diameter of an image-side surface of the fourth spacer, to intercept stray light reflected from an inner diameter surface of the fourth spacer, and further to improve imaging quality. An abutting area of the image-side surface of the fourth auxiliary spacer and an object-side surface of the fifth lens is greater than that of the object-side surface of the fourth auxiliary spacer and the image-side surface of the fourth spacer, to enhance the stability during abutting of the fifth lens.

In FIGS. 16-18, an object-side surface S1 of the first lens is a convex surface, and an image-side surface S2 of the first lens is a concave surface. An object-side surface S3 of the second lens is a convex surface, and an image-side surface S4 of the second lens is a concave surface. An object-side surface S5 of the third lens is a convex surface, and an image-side surface S6 of the third lens is a convex surface. An object-side surface S7 of the fourth lens is a convex surface, and an image-side surface S8 of the fourth lens is a convex surface. An object-side surface S9 of the fifth lens is a convex surface, and an image-side surface S10 of the fifth lens is a concave surface.

In this example, f is an effective focal length of the optical imaging lens assembly, f is 5.10 mm, and Semi-FOV is a half of a field of view, Semi-FOV is 41.24°.

In this example, in the first state, EP12<EP23<EP34, the fourth spacer has the largest thickness, and the first spacer, the second spacer, the third spacer, and the fourth auxiliary spacer have equal thicknesses. In the second state, EP34<EP23<EP12, the fourth spacer has a thickness greater than that of the third spacer, and the first spacer, the second spacer, and the fourth auxiliary spacer have equal thicknesses. In the third state, EP23<EP34<EP12, the fourth spacer has a thickness greater than that of the third spacer, and the first spacer, the second spacer, and the fourth auxiliary spacer have equal thicknesses. The thicknesses of some thinner spacers are set to be the same, to facilitate production processing of each spacer.

Table 5 illustrates a table of basic structural parameters of the optical imaging lens assembly of Example 3, wherein the units of the curvature radius, the thickness/distance, and the effective radius are millimeters (mm).

TABLE 5

| Surface | Surface | Curvature | | Material | | |
|---|---|---|---|---|---|---|
| number | type | radius | Thickness | Refractive | Abbe | |
| OBJ | Spherical | Infinity | 450 | index | number | Effective radius |
| STO | Spherical | Infinity | −0.4062 | | | |
| S1 | Aspheric | 2.1930 | 0.5661 | 1.54 | 56.00 | 1.2684 |
| S2 | Aspheric | 12.2187 | 0.2461 | | | 1.2355 |
| S3 | Aspheric | 13.4372 | 0.2000 | 1.67 | 19.20 | 1.1941 |
| S4 | Aspheric | 4.4256 | 0.5940 | | | 1.1480 |
| S5 | Aspheric | 80.0000 | 0.4572 | 1.57 | 37.31 | 1.3139 |
| S6 | Aspheric | −23.8107 | 1.0429 | | | 1.4685 |
| S7 | Aspheric | 44.7716 | 0.7906 | 1.54 | 56.00 | 2.1517 |
| S8 | Aspheric | −2.8520 | 0.8368 | | | 2.4229 |
| S9 | Aspheric | 14.0135 | 0.4987 | 1.54 | 55.65 | 3.6878 |
| S10 | Aspheric | 1.6831 | 0.4882 | | | 4.2757 |
| S11 | Spherical | Infinity | 0.2100 | 1.52 | 64.20 | 4.5365 |
| S12 | Spherical | Infinity | 0.4457 | | | 4.5865 |
| S13 | Spherical | Infinity | | | | |

Table 6 illustrates higher order term coefficients that are able to be used for each aspheric mirror surface S1-S10 in Example 3, wherein each aspheric surface type is able to be defined by Formula 1 given in Example 1 above.

TABLE 6

| Surface number | A4 | A6 | A8 | A10 | A12 | A14 | A16 |
|---|---|---|---|---|---|---|---|
| S1 | 1.5541E−03 | 2.0703E−02 | −3.3125E−02 | −4.4542E−01 | 3.5682E+00 | −1.3248E+01 | 3.0456E+01 |
| S2 | −2.6375E−03 | −2.2029E−01 | 2.2995E+00 | −1.3963E+01 | 5.5525E+01 | −1.5181E+02 | 2.9362E+02 |
| S3 | −5.0477E−02 | 1.7956E−01 | −1.2530E+00 | 7.6755E+00 | −3.1899E+01 | 9.1754E+01 | −1.8730E+02 |
| S4 | −3.7057E−02 | −2.2052E−02 | 1.0774E+00 | −8.7418E+00 | 4.3822E+01 | −1.4764E+02 | 3.4655E+02 |
| S5 | −6.9263E−02 | 1.5279E−01 | −1.1737E+00 | 5.6205E+00 | −1.8060E+01 | 4.0418E+01 | −6.4539E+01 |
| S6 | −4.3196E−02 | −6.6944E−02 | 4.1521E−01 | −1.6889E+00 | 4.5563E+00 | −8.5170E+00 | 1.1323E+01 |
| S7 | 4.6682E−04 | −2.6413E−02 | 5.4825E−02 | −9.3472E−02 | 1.0726E−01 | −8.4725E−02 | 4.6360E−02 |
| S8 | 2.5391E−02 | −5.0796E−02 | 1.0590E−01 | −1.5916E−01 | 1.6428E−01 | −1.1943E−01 | 6.2251E−02 |
| S9 | −1.2302E−01 | 4.3355E−02 | −7.3960E−03 | −1.0924E−03 | 1.3059E−03 | −4.6575E−04 | 9.8001E−05 |
| S10 | −6.2948E−02 | 2.3482E−02 | −5.0433E−03 | 1.1523E−04 | 3.0091E−04 | −1.0499E−04 | 1.9698E−05 |
| Surface number | A18 | A20 | A22 | A24 | A26 | A28 | A30 |
| S1 | −4.7073E+01 | 5.0430E+01 | −3.7616E+01 | 1.9194E+01 | −6.3925E+00 | 1.2526E+00 | −1.0955E−01 |
| S2 | −4.0769E+02 | 4.0772E+02 | −2.9101E+02 | 1.4455E+02 | −4.7453E+01 | 9.2528E+00 | −8.1122E−01 |
| S3 | 2.7504E+02 | −2.9123E+02 | 2.2022E+02 | −1.1592E+02 | 4.0334E+01 | −8.3359E+00 | 7.7464E−01 |
| S4 | −5.7771E+02 | 6.8817E+02 | −5.8165E+02 | 3.4062E+02 | −1.3139E+02 | 3.0025E+01 | −3.0788E+00 |
| S5 | 7.4452E+01 | −6.2157E+01 | 3.7176E+01 | −1.5522E+01 | 4.2947E+00 | −7.0733E−01 | 5.2474E−02 |
| S6 | −1.0856E+01 | 7.5251E+00 | −3.7363E+00 | 1.2953E+00 | −2.9774E−01 | 4.0771E−02 | −2.5173E−03 |
| S7 | −1.7425E−02 | 4.3494E−03 | −6.5536E−04 | 4.0452E−05 | 3.4848E−06 | −7.5892E−07 | 3.7839E−08 |
| S8 | −2.3471E−02 | 6.3962E−03 | −1.2444E−03 | 1.6812E−04 | −1.4953E−05 | 7.8603E−07 | −1.8483E−08 |
| S9 | −1.3611E−05 | 1.2922E−06 | −8.4091E−08 | 3.6650E−09 | −1.0103E−10 | 1.5574E−12 | −9.7738E−15 |
| S10 | −2.4033E−06 | 2.0021E−07 | −1.1460E−08 | 4.4119E−10 | −1.0827E−11 | 1.5099E−13 | −8.9100E−16 |

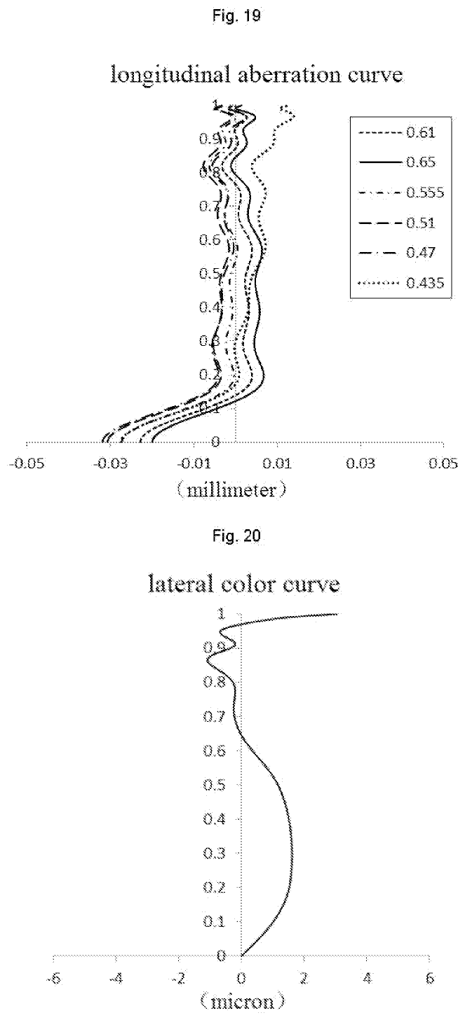

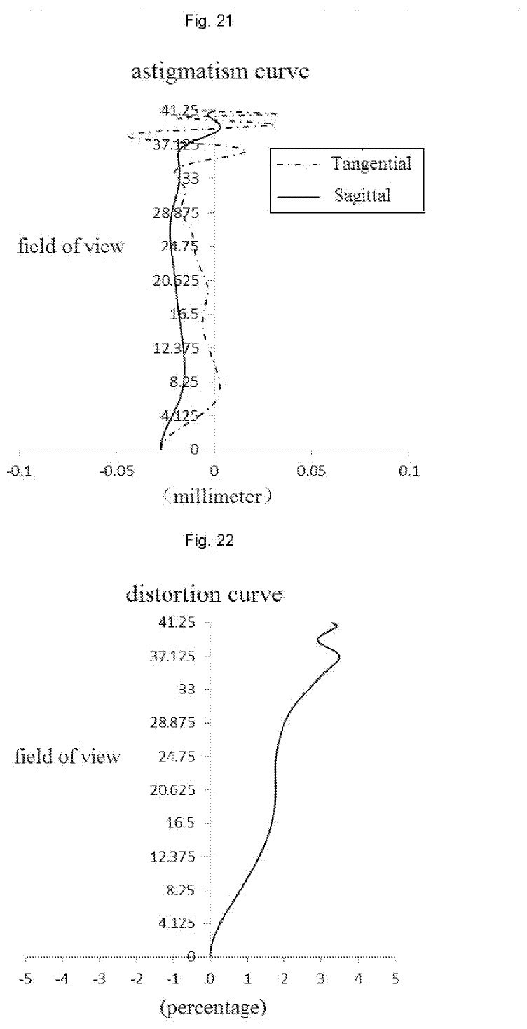

FIG. 19 illustrates a longitudinal chromatic aberration curve of the optical imaging lens assembly in Example 3, which shows that a convergence focus of light rays of different wavelengths is deviated after the light rays pass through the optical imaging lens assembly. FIG. 20 illustrates a lateral color curve of the optical imaging lens assembly in Example 3, which shows a deviation of different image heights of the light rays on the imaging surface after the light rays pass through the optical imaging lens assembly. FIG. 21 illustrates an astigmatism curve of the optical imaging lens assembly in Example 3, which shows a curvature of tangential image surface and a curvature of sagittal image surface. FIG. 22 illustrates a distortion curve of the optical imaging lens assembly in Example 3, which shows distortion magnitude values corresponding to different fields of view.

FIGS. 19-22 illustrate that the optical imaging lens assembly provided in Example 3 may achieve desirable imaging quality.

In conclusion, Examples 1-3 separately satisfy relations shown in Table 7.

TABLE 7

| | example | | | | | | | | |
|---|---|---|---|---|---|---|---|---|---|
| Conditional expression | 1-1 | 1-2 | 1-3 | 2-1 | 2-2 | 2-3 | 3-1 | 3-2 | 3-3 |
| f*tan(Semi-FOV)/CP4 | 6.31 | 6.50 | 7.66 | 6.06 | 7.09 | 9.41 | 4.30 | 4.76 | 5.03 |
| (R8 + R9)/CP4 | 3.61 | 3.72 | 4.39 | 0.94 | 1.10 | 1.45 | 10.73 | 11.87 | 12.54 |
| EP12/CT2 + EP23/CT3 | 3.13 | 2.84 | 2.68 | 3.52 | 3.19 | 3.19 | 4.32 | 3.77 | 3.92 |
| f1/EP12 + f2/EP23 | −23.96 | −9.96 | −8.59 | −8.24 | −8.70 | −8.70 | −4.22 | −9.95 | −10.43 |
| (CP1 + EP12 + CP2)/CT2 | 2.53 | 1.98 | 1.85 | 2.32 | 2.18 | 2.27 | 2.90 | 2.95 | 3.20 |
| (T34 + CT4 + T45)/(CP3 + CP4) | 2.47 | 2.51 | 2.94 | 3.02 | 3.47 | 4.45 | 2.52 | 1.91 | 1.80 |
| f3/EP23 + f4/EP34 | 72.44 | 52.47 | 51.92 | −58.02 | −64.29 | −66.20 | 50.04 | 72.53 | 71.81 |
| (CP4 + CP4b)/T45 | 10.81 | 10.65 | 9.27 | 0.71 | 0.62 | 0.48 | 1.27 | 1.16 | 1.11 |
| (f4 − f5)/CP4 | 7.59 | 7.82 | 9.21 | 14.60 | 17.07 | 22.64 | 8.18 | 9.05 | 9.56 |
| R3/R4 + CP1/CP2 | 3.83 | 3.83 | 4.17 | −6.86 | −6.86 | −6.86 | 4.04 | 4.04 | 4.04 |
| TD/ΣCP | 6.35 | 6.19 | 6.89 | 5.55 | 6.06 | 7.17 | 4.67 | 3.44 | 3.23 |
| f/(CP1 + CP2 + CP3 + CP4) | 5.08 | 5.02 | 5.70 | 6.13 | 6.80 | 8.24 | 4.64 | 3.49 | 3.27 |
| T12/CP1 | \ | \ | \ | 5.66 | 3.78 | 2.83 | \ | \ | \ |
| T23/CP2 | \ | \ | \ | 21.72 | 14.48 | 10.86 | \ | \ | \ |
| T34/CP3 | 12.78 | 8.52 | 8.52 | \ | \ | \ | \ | \ | \ |

Table 8 illustrates some parameters of the optical imaging lens assembly of Examples 1-3.

TABLE 8

| Conditional | example | | | | | | | | |
|---|---|---|---|---|---|---|---|---|---|
| expression | 1-1 | 1-2 | 1-3 | 2-1 | 2-2 | 2-3 | 3-1 | 3-2 | 3-3 |
| f | 3.76 | 3.76 | 3.76 | 5.03 | 5.03 | 5.03 | 5.10 | 5.10 | 5.10 |
| Semi-FOV | 48.75 | 48.75 | 48.75 | 42.51 | 42.51 | 42.51 | 41.24 | 41.24 | 41.24 |
| f1 | 7.56 | 7.56 | 7.56 | 4.04 | 4.04 | 4.04 | 4.77 | 4.77 | 4.77 |
| f2 | −14.70 | −14.70 | −14.70 | −10.55 | −10.55 | −10.55 | −9.67 | −9.67 | −9.67 |
| f3 | 29.49 | 29.49 | 29.49 | −43.33 | −43.33 | −43.33 | 31.98 | 31.98 | 31.98 |
| f4 | 2.35 | 2.35 | 2.35 | 6.59 | 6.59 | 6.59 | 4.91 | 4.91 | 4.91 |
| f5 | −2.81 | −2.81 | −2.81 | −4.50 | −4.50 | −4.50 | −3.59 | −3.59 | −3.59 |
| CP1 | 0.02 | 0.03 | 0.04 | 0.02 | 0.03 | 0.04 | 0.02 | 0.03 | 0.04 |
| CP2 | 0.02 | 0.03 | 0.03 | 0.02 | 0.03 | 0.04 | 0.02 | 0.03 | 0.04 |
| CP3 | 0.02 | 0.03 | 0.03 | 0.02 | 0.03 | 0.04 | 0.02 | 0.46 | 0.59 |
| CP4 | 0.68 | 0.66 | 0.56 | 0.76 | 0.65 | 0.49 | 1.04 | 0.94 | 0.89 |
| CP4b | 0.02 | 0.03 | 0.04 | 0.02 | 0.03 | 0.04 | 0.02 | 0.03 | 0.04 |
| EP12 | 0.74 | 0.55 | 0.50 | 0.49 | 0.44 | 0.44 | 0.54 | 0.53 | 0.56 |
| EP23 | 0.43 | 0.62 | 0.62 | 0.64 | 0.59 | 0.59 | 0.74 | 0.51 | 0.51 |
| EP34 | 0.61 | 0.48 | 0.54 | 0.68 | 0.72 | 0.91 | 0.72 | 0.50 | 0.54 |

It is to be noted that 1-1 in Tables 7 and 8 indicates a first state of the optical imaging lens assembly in Example 1, 1-2 indicates a second state of the optical imaging lens assembly in Example 1, and 1-3 indicates a third state of the optical imaging lens assembly in Example 1; 2-1 indicates a first state of the optical imaging lens assembly in Example 2, 2-2 indicates a second state of the optical imaging lens assembly in Example 2, and 2-3 indicates a third state of the optical imaging lens assembly in Example 2; and 3-1 indicates a first state of the optical imaging lens assembly in Example 3, 3-2 indicates a second state of the optical imaging lens assembly in Example 3, and 3-3 indicates a third state of the optical imaging lens assembly in Example 3.

The disclosure further provides an imaging device, and an electronic photosensitive element thereof is able to be a charge coupled device (CCD) or a complementary metal-oxide-semiconductor (CMOS) element. The imaging device is able to be a standalone imaging apparatus, for example, a digital camera, or is able to be an imaging module integrated on a mobile electronic apparatus, for example, a cell phone. The imaging device is equipped with the optical imaging lens assembly described above.

Apparently, the embodiments described are merely some embodiments rather than all embodiments of the disclosure. Based on the embodiments of the disclosure, all other embodiments acquired by those of ordinary skill in the art without making creative efforts fall within the scope of protection of the disclosure.

It is to be noted that the terms used herein are for the purpose of describing detailed implementation modes only and are not intended to be limiting of the illustrative implementation modes in accordance with the disclosure. As used herein, the singular is intended to include the plural unless the context clearly dictates, and furthermore, it is to be understood that the terms “include” and/or “comprise”, when used in this specification, specify the presence of features, steps, works, devices, components, and/or combinations thereof.

It is to be noted that the terms “first”, “second” and so forth, in the specification and claims of the disclosure and in the above-mentioned drawings, are used to distinguish between similar objects and not necessarily to describe a particular order or sequential order. It is to be understood that the data used in this way may be interchanged wherein appropriate, such that the implementation modes of the disclosure described herein can be implemented in other sequences than those illustrated or described herein.

The foregoing is merely the preferred embodiments of the disclosure and is not intended to be limiting of the disclosure, and various changes and modifications may be made by those skilled in the art. Any modifications, equivalent substitutions, improvements, etc. made within the spirit and principles of the disclosure are intended to fall within the scope of protection of the disclosure.

What is claimed is:

1. An optical imaging lens assembly, comprising a lens barrel, wherein the lens barrel is internally provided with:
a first lens;
a second lens;
a third lens;
a fourth lens, wherein the fourth lens has a positive refractive power;
a fifth lens, wherein the fifth lens has the largest outer diameter in all of lenses of the optical imaging lens assembly; and
a plurality of spacers, wherein the plurality of spacers at least comprise a fourth spacer, the fourth spacer is located on an image side of the fourth lens and abuts against an image-side surface of the fourth lens, and the fourth spacer is thicker than remaining spacers of the plurality of spacers;
wherein f is an effective focal length of the optical imaging lens assembly, FOV is a half of a maximum field of view of the optical imaging lens assembly, and CP4 is a thickness of the fourth spacer, f and FOV and CP4 satisfy 0<f*tan(Semi-FOV)/CP4<10; and
R8 is a curvature radius of the image-side surface of the fourth lens, R9 is a curvature radius of an object-side surface of the fifth lens, R8 and R9 and CP4 satisfy 0<(R8+R9)/CP4<15.

2. The optical imaging lens assembly according to claim 1, wherein a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, a spacer of the plurality of spacers located on an image side of the third lens and abutting against an image-side surface of the third lens is a third spacer, and EP12 is a distance between the first spacer and the second spacer, EP23 is a distance between the second spacer and the third spacer, CT2 is a center thickness of the second lens, and CT3 is a center thickness of the third lens, EP12 and EP23 and CT2 and CT3 satisfy 2<EP12/CT2+EP23/CT3<5.

3. The optical imaging lens assembly according to claim 1, wherein a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, a spacer of the plurality of spacers located on an image side of the third lens and abutting against an image-side surface of the third lens is a third spacer, and EP12 is a distance between the first spacer and the second spacer, EP23 is a distance between the second spacer and the third spacer, f1 is an effective focal length of the first lens, and f2 is an effective focal length of the second lens, EP12 and EP23 and f1 and f2 satisfy −25<f1/EP12+f2/EP23<0.

4. The optical imaging lens assembly according to claim 1, wherein a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, the second lens has the smallest center thickness in all of the lenses of the optical imaging lens assembly, and CP1 is a thickness of the first spacer, EP12 is a distance between the first spacer and the second spacer, CP2 is a thickness of the second spacer, and CT2 is a center thickness of the second lens, EP12 and CP1 and CT2 and CP2 satisfy 1<(CP1+EP12+CP2)/CT2<4.

5. The optical imaging lens assembly according to claim 1, wherein a spacer of the plurality of spacers located on an image side of the third lens and abutting against an image-side surface of the third lens is a third spacer, and T34 is an on-axis distance from the image-side surface of the third lens to an object-side surface of the fourth lens, CT4 is a center thickness of the fourth lens, T45 is an on-axis distance from the image-side surface of the fourth lens to an object-side surface of the fifth lens, CP3 is a thickness of the third spacer, and CP4 is a thickness of the fourth spacer, T34 and T45 and CT4 and CP3 and CP4 satisfy 1<(T34+CT4+T45)/(CP3+CP4)<5.

6. The optical imaging lens assembly according to claim 1, wherein a spacer of the plurality of spacers located on an image side of the second lens and abutting against an image-side surface of the second lens is a second spacer, a spacer of the plurality of spacers located on an image side of the third lens and abutting against an image-side surface of the third lens is a third spacer, and f3 is an effective focal length of the third lens, EP23 is a distance between the second spacer and the third spacer, f4 is an effective focal length of the fourth lens, and EP34 is a distance between the third spacer and the fourth spacer, EP23 and EP34 and f3 and f4 satisfy −70<f3/EP23+f4/EP34<80.

7. The optical imaging lens assembly according to claim 1, further comprising a fourth auxiliary spacer located on an image side of the fourth spacer and abutting against an image-side surface of the fourth spacer, wherein CP4 is a thickness of the fourth spacer, CP4b is a thickness of the fourth auxiliary spacer, and T45 is an on-axis distance from the image-side surface of the fourth lens to an object-side surface of the fifth lens, T45 and CP4b and CP4 satisfy 0<(CP4+CP4b)/T45<11.

8. The optical imaging lens assembly according to claim 1, wherein f4 is an effective focal length of the fourth lens, f5 is an effective focal length of the fifth lens, and CP4 is a center thickness of the fourth lens, f4 and f5 and CP4 satisfy 5<(f4-f5)/CP4<25.

9. The optical imaging lens assembly according to claim 1, wherein a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, the second lens has the largest refractive index in all of the lenses of the optical imaging lens assembly, and R3 is a curvature radius of an object-side surface of the second lens, R4 is a curvature radius of an image-side surface of the second lens, CP1 is a thickness of the first spacer, and CP2 is a thickness of the second spacer, R3 and R4 and CP1 and CP2 satisfy −10<R3/R4+CP1/CP2<5.

10. The optical imaging lens assembly according to claim 1, wherein TD is an on-axis distance from the object-side surface of the first lens to the image-side surface of the fifth lens, and ΣCP is a sum of thicknesses of all of the spacers, ΣCP and TD satisfy 3<TD/ΣCP<8.

11. The optical imaging lens assembly according to claim 1, wherein a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, a spacer of the plurality of spacers located on an image side of the third lens and abutting against an image-side surface of the third lens is a third spacer, and f is an effective focal length of the optical imaging lens assembly, CP1 is a thickness of the first spacer, CP2 is a thickness of the second spacer, CP3 is a thickness of the third spacer, and CP4 is a thickness of the fourth spacer, f and CP1 and CP2 and CP3 and CP4 satisfy 0<f/(CP1+CP2+CP3+CP4)<10.

12. The optical imaging lens assembly according to claim 1, wherein when an image-side surface of an ith lens of the lense and an object-side surface of an (i+1)th lens of the lenses are concave surfaces, T(i, i+1) is an on-axis distance between the image-side surface of the ith lens and the object-side surface of the (i+1)th lens, and CPi is a thickness of an ith spacer of the plurality of spacers satisfy 0<T(i, i+1)/CPi<25, wherein the ith spacer is a spacer of the plurality of spacers located on an image side of the ith lens and abutting against the image-side surface of the ith lens, and i is 1, 2, 3 or 4.

13. The optical imaging lens assembly according to claim 1, wherein at least two of the first lens to the fifth lens have positive refractive powers.

14. The optical imaging lens assembly according to claim 1, wherein the first lens has a positive refractive power, and the fifth lens has a negative refractive power.

15. The optical imaging lens assembly according to claim 1, wherein the first lens is a meniscus lens having a convex object-side surface.

16. The optical imaging lens assembly according to claim 1, wherein a refractive index of at least one lens of the optical imaging lens assembly is greater than that of the first lens.

17. The optical imaging lens assembly according to claim 1, wherein f1 is an effective focal length of the first lens, f2 is an effective focal length of the second lens, and f3 is an effective focal length of the third lens, f1 and f2 and f3 satisfy |f1|<|f2|<|f3|.

18. An optical imaging lens assembly, comprising a lens barrel, wherein the lens barrel is internally provided with:
a first lens;
a second lens;
a third lens;
a fourth lens, wherein the fourth lens has a positive refractive power;
a fifth lens, wherein the fifth lens has the largest outer diameter in all of lenses of the optical imaging lens assembly; and
a plurality of spacers, wherein the plurality of spacers at least comprise a third spacer and a fourth spacer, the third spacer is located on an image side of the third lens and abuts against an image-side surface of the third lens, the fourth spacer is located on an image side of the fourth lens and abuts against an image-side surface of the fourth lens, and the fourth spacer is thicker than remaining spacers of the plurality of spacers; wherein
T34 is an on-axis distance from the image-side surface of the third lens to an object-side surface of the fourth lens, CT4 is a center thickness of the fourth lens, T45 is an on-axis distance from the image-side surface of the fourth lens to an object-side surface of the fifth lens, CP3 is a thickness of the third spacer, and CP4 is a thickness of the fourth spacer, T34 and T45 and CT4 and CP3 and CP4 satisfy 1<(T34+CT4+T45)/(CP3+CP4)<5.

19. The optical imaging lens assembly according to claim 18, wherein a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, a spacer of the plurality of spacers located on an image side of the third lens and abutting against an image-side surface of the third lens is a third spacer, and EP12 is a distance between the first spacer and the second spacer, EP23 is a distance between the second spacer and the third spacer, CT2 is a center thickness of the second lens, and CT3 is a center thickness of the third lens, EP12 and EP23 and CT2 and CT3 satisfy 2<EP12/CT2+EP23/CT3<5.

20. The optical imaging lens assembly according to claim 18, wherein a spacer of the plurality of spacers located on an image side of the first lens and abutting against an image-side surface of the first lens is a first spacer, a spacer of the plurality of spacers located on an image side of the second lens and abutting against an image-side surface of the second lens is a second spacer, a spacer of the plurality of spacers located on an image side of the third lens and abutting against an image-side surface of the third lens is a third spacer, and EP12 is a distance between the first spacer and the second spacer, EP23 is a distance between the second spacer and the third spacer, f1 is an effective focal length of the first lens, and f2 is an effective focal length of the second lens, EP12 and EP23 and f1 and f2 satisfy −25<f1/EP12+f2/EP23<0.
